(19) United States
(12) Patent Application Publication
(10) Pub. No.: US 2005/0274295 A1
(43) Pub. Date: Dec. 15, 2005

(54) Multi-function construction material, system, and method for use around in-ground foundations

(75) Inventors: Robert R. Setter, Abbots-Ford (CA); Mehmet Serdar Serdaroglu, Iowa City, IA (US); Colby Corson Swan JR., Iowa City, IA (US)

Correspondence Address: MCKEE, VOORHEES & SEASE, P.L.C., 801 GRAND AVENUE, SUITE 3200, DES MOINES, IA, 50309-2721, US

(73) Assignee: University of Iowa Research Foundation, Iowa City, IA (US)

(21) Appl. No.: 11/107,278

(22) Filed: Apr. 15, 2005

Related U.S. Application Data
(60) Provisional application No. 60/562,711, filed on Apr. 16, 2004.

(51) Int. Cl. C04B 7/00; C04B 14/00; E04C 3/16; E04F 13/06

(52) U.S. Cl. 106/816; 106/817

(57) ABSTRACT

A construction material and method of use comprises stone aggregate having physical properties like those of limestone approved by the Iowa State DOT for use in 3i mainline interstate highway concrete stone having a substantial majority of particle sizes between 1 millimeters and 3.35 millimeters. The construction material is adapted for placement under-slab or between outer walls and ground, including between footings from base of footings to grade. The material is optimized to be multi-functional. It can provide drainage, radon mitigation, structural support and thermal insulation, and can be a non-chemical (physical) barrier to subterranean termites.

### I. CROSS-REFERENCE TO RELATED APPLICATIONS

This application claims priority under 35 U.S.C. § 119 of a provisional application Ser. No. 60/562,711 filed Apr. 16, 2004, which application is hereby incorporated by reference in its entirety.

### II. BACKGROUND OF THE INVENTION

A. Field of the Invention

The present invention relates to construction materials and, in particular, materials and methods for use of such materials around in-ground portions of buildings or other structures.

B. Problems in the Art

Many engineering issues arise with respect to construction and longevity of structures constructed on or partially in the ground. Some of those issues are obvious, such as physical support of the structure and its cost. Others are more subtle and vary by location. For example, different soil types or geological features may favor certain construction materials and techniques. Indigenous water problems and insects can drive the selection of construction materials and the design used for a building. Still further, health and environmental concerns of local governments, building owners, or inhabitants can affect how the structure is designed and built. Laws and regulations may dictate what materials can be used and how buildings are constructed.

There have been continuous advancements in construction techniques and materials over the years. However, it remains conventional to use concrete foundations and footings in many constructions. Cost, longevity, strength, availability, and ease of use for different designs and sites make concrete a common choice. However, wood and other less massive materials are still used for a substantial amount of above-ground and interior structural and other features of buildings.

In light of continued popularity of concrete foundations in combination with above-grade and interior wood construction materials, attention has turned to improving other construction materials and methods used in conjunction with conventional concrete foundations and the structures they support. Materials and techniques have been developed regarding the areas around the foundation.

For example, materials have been engineered to backfill around the foundation to assist in support of the foundation in the ground. Techniques for compacting or otherwise deterring shifting, settling, or slumping of the materials have also been developed. Materials deemed to have desirable specific properties to meet this need have been commonly placed in layers under or near foundations. The materials can be tamped or compacted to resist settling.

In another example, some designs include materials around the foundation specifically engineered for water or moisture deterrence or diversion. Tiling or other drainage structure can be engineered with other materials to attempt to control hydraulic properties near the foundation.

Some designs include materials around the foundation designed to deter insects from trying to penetrate the foundation. Impermeable barriers can be used to absolutely block penetration by fluids or insects. Chemical barriers can be attempted to kill insects or deter them from attempting to reach the foundation.

Unfortunately, the nature of concrete does not guarantee that it is, or that it will remain, impervious during its normal life. Cracks or pores can develop during placement or later after curing. Also, gaps can exist from utility penetrations, and expansion of cold joints. This provides opportunities for water, insects, or other fluid or gas phase substances to pass through a foundation wall and damage or affect the interior.

Despite the existence of these types of problems, attempts to address them tend to be driven by the specific priorities and factors involved with each one. For example, materials that are compactable to provide a good, solid under-layer to foundations and slabs tend to be such things as soil and sand. Materials for water drainage tend to be relatively large (e.g. gravel or stones) with substantial interstitial spaces for higher permeability to fluids. Barriers to insects are usually either impermeable (e.g. metal sheet), or chemical instead of physical.

In the case of insects, chemical barriers are deemed advantageous because they are relatively inexpensive, have some flexibility in application, and do not require an additional type of material in the construction. However, normally they have a relatively short effectiveness (5 to 7 years). Reapplication after construction is in place, e.g., under slab, is expensive and difficult (it can require drilling and resealing). Built-in reapplication systems are expensive. Furthermore, environmental and health concerns arise; and increasingly so. Some locations do not allow use of such chemicals because of toxicity and environmental concerns. On the other hand, physical barriers to insects tend to be impractical and costly, at least for totally encasing a foundation. They also tend to be inconsistent with such things as drainage or permeability for water and other fluids.

Attempts have been made to address insect barrier issues. For example, several attempts have been made to utilize specially formulated granular materials to surround the in-ground portion of a structure as a termite barrier. U.S. Pat. No. 4,823,520 to Ebeling et al. and U.S. Pat. No. 5,094,045 to Tamashiro are examples. With regard to the Ebeling patent, sand of a specified grain size is claimed to block termites. With regard to the Tamashiro patent, basaltic granular materials of a certain grain size range are utilized. They specifically teach a particle size and type, and rationales for selecting the same for termite deterrence.

It will therefore be seen that the above-mentioned attempts tend to focus on one concern; structural support, drainage, or insect barrier. The properties of their solutions are maximized for the problem they are designed to mitigate. However, those properties may conflict with, or ignore, the other sub-grade issues involved in construction of buildings. Furthermore, some of the current attempts do not form a functioning part of the building, but rather act solely for its targeted ancillary function (e.g. termite barrier). Some are not viable for certain situations (e.g., very deep foundations, very wet environments, etc.). Thus, there is a need in the art for a construction material surrounding in-ground structures that is multi-functional and improves over the state of the art.

### III. SUMMARY OF THE INVENTION

A. Objects, Features, and Aspects of the Invention

It is therefore a principal object, feature, advantage, and aspect of the present invention to provide a construction material, and apparatus, systems, and methods for its use, that improves over the state of the art. Further objects, features, advantages, and aspects of the invention include a construction material, and apparatus, systems, and methods for use of the construction material as above described which:
a) is multi-functional.
b) is environmentally friendly.
c) addresses not only structural support issues but environmental and health concerns.
d) is energy efficient by reducing energy consumption for the building or structure.
e) is durable; engineered for the life of the structure.
f) is non-chemical, but is compatible with chemical or insect baiting systems.
g) reduces the call for chemical insecticides and pesticides.
h) can be used for providing drainage around the structure.
i) can be installed with the original building or retrofitted.
j) can be utilized comprehensively around the in-ground portion of a structure or for a spot remediation.
k) is adaptable to a wide variety of construction types and locations.
l) has flexibility to adapt to different engineering designs.
m) can obviate the need for additional cost and materials, for example specialized drainage materials, insulation materials, radon mitigation systems, and termite protection.
n) can be installed in a variety of forms and configurations, including in combination with other construction materials.
o) can be a part of the construction.

These and other objects, features, advantages, and aspects of the invention will become more apparent with reference to the accompanying specification and claims.

B. Summary of Aspects of the Invention

In one aspect of the invention, a construction material comprises stone aggregate of a certain durability, with a substantial majority of the particles of a size between approximately 1.0 millimeter (mm) and 4.0 mm, for use around in-ground portions of structures. The material has been found to not only deter penetration by the eastern subterranean termite (Reticulitermes flavipes), but also provide drainage, thermal insulation, and radon mitigation functions. It also is able to function sufficiently as an underlying supporting material beneath concrete slabs. One example of such stone is limestone meeting the physical properties of an Iowa State Department of Transportation 3i rating for mainline interstate highway concrete mix. Other types of stone or aggregate substantially meeting these physical properties also can be used.

A method according to an aspect of the invention includes placing a layer of limestone aggregate, having a substantial majority of particles in the size range of approximately 1.0 to 4.0 mm, between an in-ground foundation and the ground. In another aspect of the method, the layer can function for one or more of drainage, a physical termite barrier, thermal insulation, and radon mitigation. It can also assist in structural support or resistance against shifting or settling.

According to further aspects of the invention, the material can be used in combination with other construction materials, components, or techniques. For example, drainage pipes or tiling can be used in conjunction with a layer of the material to assist in drainage or water management around the foundation. Techniques can be used to preserve the layer of material against shifting or contamination. Additional physical barriers and materials can be used within or at margins of the material.

### IV. BRIEF DESCRIPTION OF THE DRAWINGS

FIGS. 1A and B are graphs of particle size distributions for several exemplary embodiments of the present invention.

FIG. 2 is a drawing indicating the typical under-slab components of the termite barrier system alone, and additional optional features.

FIG. 3 is a typical section of an example of an entire system under-slab and around sidewalls, with all components indicated.

FIG. 4 is a section of a system as installed under-slab only.

FIG. 5 is an illustration detailing the installation of the system under stoops, where sidewalks penetrate the building entry through doorways for slab-on-grade structures.

FIG. 6 is an illustration detailing the installation of the system under stoops, where sidewalks penetrate the building entry through doorways for full basement structures.

FIG. 7 is a detail indicating installation of system and components on large structures with a brick ledge on a deep foundation, and an above ground outside wall of brick. Foundation walls are set on caissons.

FIG. 8 is an illustration detailing the specifics of system installation on buildings with half basement/half slab-on-grade construction.

FIG. 9 is a detail indicating installation of system and components on large structures with a brick ledge on the foundation, and an above ground precast concrete wall. Foundation walls are set on caissons. Note in FIG. 9 to the right, optionally a 3″ diameter perforated drain tile covered with fabric (socked) forms a closed loop within CLA under the slab, around the perimeter of the basement for radon collection.

FIG. 10 is a detail indicating installation of system and components in slab-on-grade structures with a brick ledge, and an above ground outside wall of brick.

FIG. 11 is a detail drawing of an alternative cap embodiment.

FIG. 12 is a detail drawing of an alternative cap.

FIG. 13 is a detail drawing of an alternative cap.

FIG. 14 is an illustration of pipe collars to be used on utility penetrations through sidewalls (not through slab).

FIG. 15 is a perspective, with a partial cut-aways, of the pipe collar of FIG. 14.

FIG. 16 is an illustration detailing the placement of rigid installation on the outside wall (if desired) ensuring it is completely encapsulated within 6 inches of CLA at all locations.

### V. DETAILED DESCRIPTION OF EXEMPLARY EMBODIMENTS OF THE INVENTION

A. Overview

For a better understanding of the invention, several specific examples of the invention will now be described in detail. These examples illustrate but a few ways the invention can be implemented. The invention is not limited to these several examples.

In this detailed description of examples, frequent reference will be taken to the drawings. Reference numerals and letters are used to indicate certain parts or locations in the drawings. The same reference numbers and letters are used to indicate the same or analogous parts and locations throughout the drawings, unless otherwise indicated.

The context of most of the exemplary embodiments will be with respect to at least partially in-ground structures in the continental United States, in particular, the upper Midwest in the state of Iowa. The most common insect causing damage to buildings in this geographic location is the Eastern Subterranean Termite (Reticulitermes flavipes).

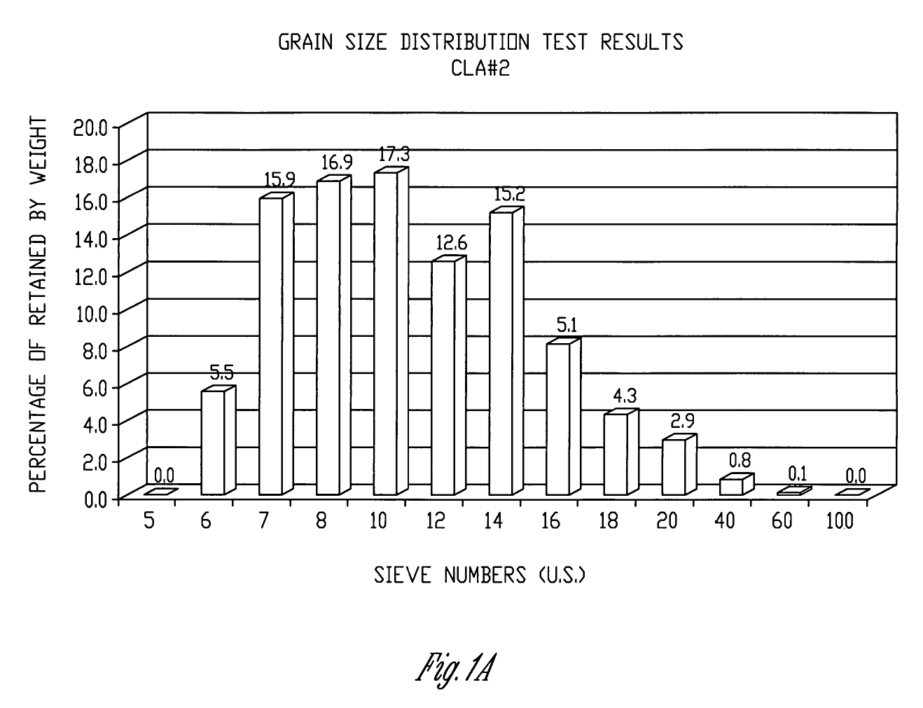

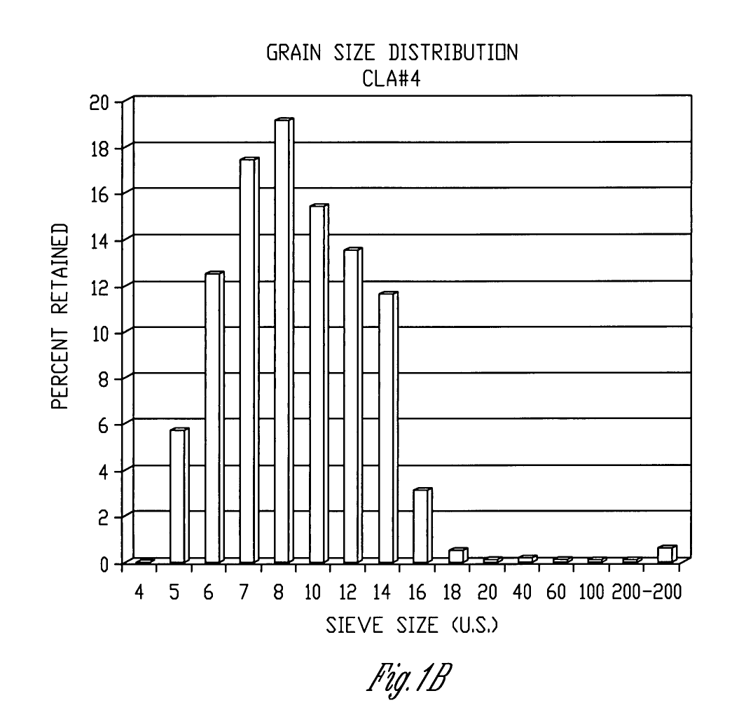

B. Material—FIG. 1

FIG. 1 diagrammatically illustrates an exposed surface of material 10 according to one aspect of the invention. Material 10 is crushed and screened limestone aggregate (sometimes referred to as “CLA” herein) with the following specifications for the Eastern Subterranean Termite:

TABLE 1

| Characteristic | Value |
|---|---|
| Rock type: | Limestone |
| Specific gravity: | 2.655 |
| Percent absorption: | 1.14 |
| LA abrasion percent loss: | 30% |
| Particle size: | ≧95% passing sieve size 5 (4.0 mm) |
| Particle size: | ≦5.0% passing sieve size 18 (1.000 mm) |
| Dust and Fines: | <2.0% passing sieve size 200 |
| Mohs Hardness Scale | 3.5 |

As will be discussed in more detail later, preferable particle size distribution is within certain parameters. Indicated proportions that fall within different screen sizes are set forth. The material is optimized to perform all functions well. The best aggregate mix (gradation) found to encompass all functions is presented. For illustration, examples of size ranges of mixtures according to the invention are included in graphs (histograms) of FIGS. 1A and B. A sieve analysis table (see Table 4A) indicating the portion of material by weight captured on each screen is given for the mixture example (called “CLA #2”) of FIG. 1A. The mixture of FIG. 1A is believed to be one of several possible mixtures having particle sizes pushed to a more minimum particle size direction.

The mixture of FIG. 1B is believed to one (called “CLA #4”) of several possible mixtures at the course end of the gradation that we have field tested. This material 10 mixture is also functioning well as a termite barrier. It has around 48% retained in the screen 8-12 size range. However, outside that range the particle sizes are pushed much farther to the larger end of the spectrum. Note that mixture CLA#4 does not have ≧95% passing a screen 6, rather ≧95% passing screen 5, but has no more than 13% retained on screen 6.

Thus FIGS. 1A and B indicate generally the range of particle size distributions suitable to provide the multi-functional capability of the material. It is believed any larger particle sizes than those of FIG. 1B may lose the termite barrier function. However, the larger particle size range will increase void space, and thereby increase drainage, thermal insulation and radon gas flow rate.

Limestone can vary in its characteristics dependant upon the rock quarry and the specific beds within a quarry from which it is taken. Material 10 of FIG. 1 is a product named EXP/TBM, product code 7512, available from River Products Company, Inc., Iowa City, Iowa. It qualifies as DOT (Iowa State Department of Transportation) certified 3i (Interstate) highway mainline concrete aggregate, and is the most durable grade of limestone available in the state of Iowa. (An alternative product name from River Products Company is EXP-4/TBM).

It has been found that material 10 is indicated to work effectively to deter Eastern Subterranean Termites from penetration according to the same criteria discussed in the Ebeling and Tamashiro patents. Despite CLA or material 10 having a broader specified range of particle sizes and being made from different material from the two stated U.S. patents, lab and field testing indicates the particles of material 10 are successful at preventing termite tunneling.

But further, permeability of material 10 has tested to be sufficient to provide additional advantageous functions for building construction. It provides a functional level of drainage for hydraulic purposes around in-ground foundational structures. The permeability has tested to be sufficient for radon mitigation purposes, with a free void space of approximately 45% when it is not mechanically compacted. When mechanically compacted to proctor 10 (90% of maximum compaction), the void space remains at 41%; at proctor 5 (95% of maximum compaction) the free void space is 37.7%. At the maximum compaction possible, this material retains a free void space of 34.4%. EPA guidelines for aggregate used in radon mitigation call for a 4 inch layer of larger sized particles (½-1 inch) with a free void space of approximately 50%. As discussed later, an exemplary specification for material 10 is a 6 inch layer of smaller particles that, as described above, have approximately 45% free void space when not mechanically compacted and the above identified free void space at various compactions.

Testing indicates that limestone aggregate has thermal insulation properties allowing it to function as thermal insulation. The hardness of material 10 has been found to allow it to serve, if needed or desired, as a supporting layer, such as under concrete slabs, without significant detriment to the other functions identified above.

Compression tests indicate a substantial resistance to fracture (e.g., material 10 will support loads of 400 kPa without any fracture. Fracture of individual particles occurred under loads of 1600 kPa). This indicates material 10 will remain stable under loads imposed by most concrete slabs and can take relatively extreme loads. Furthermore, if compaction of CLA 10 is required, it can be well compacted to proctor 10 or 5 when optimum water content is satisfied. The maximum dry unit weight of CLA 10 under optimum water content of 6% is 17.35 kN/m³. Triaxial compression tests indicate failure of CLA material 10 will occur at approximate loads of 2000 kPa under a confining stress of 400 kPa. The corresponding friction angle for CLA is around 41° for uncompacted conditions and 46° for compacted conditions. These test results indicate that CLA is very hard and very strong. The friction angle for clean sand in similar condition would be approximately 24°, indicating failure or collapse at much lower loads. Furthermore, CLA has a very low porosity and will absorb very little water into the individual particles. As a result it will not expand and contract with changing water conditions, resulting in improved stability for the concrete structure it is supporting.

A comparison of friction angles (in degrees) for sands and for CLA material 10 is shown in Tables 2 and 3, respectively, below:

TABLE 2
Ranges of friction angles for sands (in degrees)

| | Loose | Dense |
|---|---|---|
| Uniform sand, rounded particles | 27 | 35 |
| Well graded sand, angular particles | 33 | 45 |
| Sandy gravel | 35 | 50 |
| Silty sand | 27-30 | 30-34 |

Reference: R. F. Craig, Soil Mechanics, 5^{th} Edition, Chapman & Hall, 1993.

TABLE 3

| | | | Friction |
|---|---|---|---|
| CLA | Principle | Confining | Angle, |
| Sample | stress, σ_{1(kPa)} | stress, σ_{3(kPa)} | φ(Degree) |
| Loose | 994.2 | 200 | 41.7 |
| Loose | 1935.2 | 400 | 41.1 |
| Dense | 1270.4 | 200 | 46.7 |
| Dense | 2424.9 | 400 | 45.8 |

Therefore, material 10 is multi-functional as a single construction material. Construction material 10 can advantageously be used between an in-ground portion of a structure and the ground; horizontally, vertically or otherwise. Material 10 can be used whether beneath an overlying structure or along a side of a structure. It can be used in spaces or cavities between foundational pieces. Thus, crushed limestone aggregate, of the grade previously discussed, limited to approximately the above-identified size range, provides a plurality of advantageous functions, if needed, in a single material. The grade is of relatively high durability. Other types of stone will work that substantially meet the same physically properties. The particles do not break down or dissolve and are heavy enough to not be carried by termites. They also maintain voids when compacted.

The range of size of particles of material 10, in part, is determined by the type of application. For example, different types of insects, including different species of termites, may indicate adjustment of the outside limits of the range. For example, smaller species of termites may allow the range to be narrowed somewhat, and larger may indicate a slight expansion of limits of the range. The Tamashiro patent specifies that from approximately 45% to approximately 65% of the particles should be within the size range 1.7 mm to 2.4 mm. This is based upon testing to prevent tunneling by the larger and more aggressive Formosan termite (Coptotermes formosanus). The material 10 specified herein falls into the very lowest proportion of the targeted particle size range of Tamashiro et al., with 40%-45% of the particles in the 1.7 nun to 2.4 mm size range. However, material 10 is specified for the allowable proportions of size ranges (gradation) outside this narrow target range for termite prevention. In particular the gradation is specified to minimize small particles, (dust and fines ≦Screen 200), while increasing the content of larger particles (screens 4-7). This becomes an important issue when considering the multi-functional nature of material 10. Increased proportions of dust and fines could not only result in failure of the termite barrier qualities, they can also reduce or prevent other functions such as drainage, radon mitigation and thermal insulation. All of these functions depend upon the void spaces in the aggregate being maintained. Thus material 10 was engineered to maximize the void spaces while retaining the termite barrier quality. However, including too many larger particles (screen 4) within the mix very quickly results in separation and layering of like-sized particles as the aggregate is handled. As a result, including too many larger particles results in layers of material that are outside of the specified size range when the material is applied at a construction site. Also, layers of larger particles can be more easily penetrated by termites. Thus, it is preferable that the particle size distribution is well-graded across all screen sizes within the target range size (to deter separation into sizes), with particular approximate percentages falling into each size category as indicated in Table 4A. FIG. 1 is a graphical representation of Table 4A.

TABLE 4A
Optimized Particle Size Distribution (CLA#2) Across all Sieves
Dry Weight Used In Test 282.12 gr
TEST RESULTS

| Sieve Size | | Weight(gr) | | | | | % |
|---|---|---|---|---|---|---|---|
| Metric | | Sieve + | | Weight | % | | Pass- |
| (mm) | US | Sample | Sieve | Retained | Retained | Final | ing |
| 4.000 | 5 | 412.14 | 412.14 | 0 | 0.0 | 0 | 100.0 |
| 3.350 | 6 | 428.95 | 413.43 | 15.52 | 5.5 | 5.5 | 94.5 |
| 2.800 | 7 | 438.33 | 393.74 | 44.59 | 15.9 | 21.5 | 78.5 |
| 2.360 | 8 | 432.45 | 385.26 | 47.19 | 16.9 | 38.4 | 61.6 |
| 2.000 | 10 | 429.71 | 381.19 | 48.52 | 17.3 | 55.7 | 44.3 |
| 1.700 | 12 | 378.79 | 343.61 | 35.18 | 12.6 | 68.3 | 31.7 |
| 1.400 | 14 | 386.72 | 344.22 | 42.5 | 15.2 | 83.5 | 16.5 |
| 1.180 | 16 | 352.09 | 329.36 | 22.73 | 8.1 | 91.6 | 8.4 |
| 1.000 | 18 | 339.89 | 327.84 | 12.05 | 4.3 | 95.9 | 4.1 |
| 0.850 | 20 | 525.52 | 517.27 | 8.25 | 2.9 | 98.8 | 1.2 |
| 0.425 | 40 | 493.91 | 491.58 | 2.33 | 0.8 | 99.7 | 0.3 |
| 0.250 | 60 | 481.68 | 481.38 | 0.3 | 0.1 | 99.8 | 0.2 |
| 0.150 | 100 | 348.02 | 347.92 | 0.1 | 0.0 | 99.8 | 0.2 |

| | | | |
|---|---|---|---|
| PAN | 370.23 | 369.70 | 0.53 |
| TOTAL | | | 279.79 |

Table 4B is similar to Table 4A but for CLA#4.

TABLE 4B
Optimized Particle Size Distribution (CLA#4) Across all Sieves

| ORIGINAL DRY WEIGHT | | | | | | 176.9 | |
|---|---|---|---|---|---|---|---|
| DRY WEIGHT WASHED SAMPLE | | | | | | 175.8 | |
| SIEVE SIZE | | WEIGHT | % | | % | SPECIFICATIONS | |
| METRIC | U.S. | RETAINED | RETAINED | FINAL | PASSING | MINIMUM | MAXIMUM |
| 4750 | 4 | 0 | 0 | | 100 | | |
| 4000 | 5 | 10 | 5.7 | | 94.3 | | |
| 3350 | 6 | 22.2 | 12.5 | 18.2 | 81.8 | A MINIMUM OF | |
| 2800 | 7 | 30.8 | 17.4 | | 64.4 | 50.0% OF THE | |
| | | | | | | TOTAL PRODUCT | |
| | | | | | | SHALL PASS | |
| 2360 | 8 | 33.7 | 19.1 | | 45.3 | THE NO. 6 SIEVE | |
| 2000 | 10 | 27.4 | 15.4 | | 29.9 | AND BE RETAINED | |
| | | | | | | ON THE NO. 18 | |
| | | | | | | SIEVE - U.S. | |
| 1700 | 12 | 23.8 | 13.5 | | 16.4 | | |
| 1400 | 14 | 20.6 | 11.6 | | 4.8 | | |
| 1180 | 16 | 5.5 | 3.1 | | 1.7 | | |
| 1000 | 18 | 0.9 | 0.5 | 80.6 | 1.2 | | |
| 850 | 20 | 0.2 | 0.1 | | 1.1 | | |
| 425 | 40 | 0.4 | 0.2 | | 0.9 | | |
| 250 | 60 | 0.1 | 0.1 | | 0.8 | | |
| 150 | 100 | 0.1 | 0.1 | | 0.7 | | |
| 75 | 200 | 0.1 | 0.1 | | 0.6 | | |

| | | |
|---|---|---|
| PAN | 0 | |
| TOTAL | 176.9 | 100 |

One other advantage to specifying ≧88% of the particles in the 1.0 mm-3.35 mm size range is resilience to contamination. Contamination on the job site during installation is one of the main reasons cited by other aggregate barriers for failure. Specifying clearly the total size range and also increasing the layer thickness from 4 inches (Tamashiro) to 6 inches helps to diminish the impact of contamination. The extra depth also provides increased insulation, increased drainage and increased flow volume for gases.

It is preferable that material 10 be well graded within the specified range. Basically CLA has broadened the size range and skewed it towards larger sized particles.

If compaction of material 10 is required, then by adding water and compacting, specific proctor values can be attained. However, because it is a hard, non-cohesive, granular material, it is not indicated to be, and in fact is difficult, to compact like normal back fill and under-slab soils. But it has been found that, because it is very free flowing, it will settle extremely well with vibration. Therefore, an adequate amount of compaction can generally be achieved by applying vibration to material 10 once in place. Because it is highly resistive to breakage or fracture, very little further settling is expected after vibration.

It has be found that compaction of back fill adjacent to material 10 should provide ample vibration to settle material 10 when used as a layer in side wall construction. Under-slab compaction of sub soils is recommended prior to placement of material 10 over it. Vibration or other techniques can be used to settle material 10 once in place over the compacted subsoils. Mechanical methods could be used to settle material 10 when used under-slab.

Even though material 10 settles well, and thus in a sense can be somewhat compacted, it remains relatively highly permeable, and therefore retains the multiple functions described above.

For example, even when settled, it meets industry standards for a well-drained aggregate material. It is indicated that a six inch layer around the entire foundation can play a functional role in a drainage system. Furthermore, drain tile or other drainage conduits can easily be incorporated directly into material 10, including at the base of footings, to reduce hydrostatic pressure around a building foundation. FIG. 1 shows by illustration the size of the aggregate of material 10 relative to a United States dime. It can be seen that particle size is relatively small compared to, for example, pea gravel or river stones.

Furthermore, thermal conductivity has been shown to be surprisingly low. It was estimated to have an R factor of at least 1 for each 3.3 inches of thickness based upon standard equations for spheres made of limestone from the Heat Transfer Handbook. Lab tests have indicated at least an R factor of 5 for 7 inches of material 10. As mentioned, substantial variation in physical properties of limestone is dependent upon the beds it is taken from. The required properties of raw limestone material for material 10 make it preferable it be taken from stone bed(s) such as certified by the Iowa State DOT for use as aggregate with a 3i rating for mainline interstate highway concrete mix. Class 3i durability aggregates will produce no deterioration of pavements on the Interstate Road System after 30 years of service and less than 5% deterioration of the joints after 35 years.

The free void space of material 10 (44.9% loose-37.7% compacted) in a 6″ layer will allow it to function for radon mitigation. EPA regulations for this function specify a 4 inch layer of coarse aggregate (½″ to 1 inch recommended) with a free void space of at least 40-50%. Similar to later described systems, a plastic sheet (vapor barrier) preferably is placed on top of the aggregate before installing the concrete slab. A mechanical exhaust system, of any of a variety of types commercially available, could be installed to exhaust gaseous phase substances in material 10 to atmosphere. Specific EPA guidelines for installing radon mitigation systems should be followed when designing and placing material 10 in place of the coarser aggregate currently specified by the EPA for this purpose. The EPA installation guidelines do not conflict with installation guidelines for the installation of the multi-functional barrier described, and incorporating the radon mitigation function into the described system does not compromise termite barrier qualities. However, specific details that will allow all functions claimed to work must be addressed. For inclusive details of radon mitigation, reference can be taken to the appropriate publicly available EPA publications (EPA/625/R-92/016; Radon prevention in the design and construction of schools and other large buildings, EPA/402-k-01-002 Building radon out; A step by step guide on how to build radon resistant homes) which are incorporated by reference herein.

One issue regarding most present radon mitigation devices is that they are under slab only, and do not address foundation sidewalls. The installation systems described herein include foundation sidewalls and under-slab areas. Preliminary modeling of radon gas flow utilizing the described system indicates a substantial increase in the depressurized area of soil surrounding a foundation when compared to utilizing only a sub-slab layer of aggregate with a power-vented chimney.

However, the present system with material 10 can function as an under slab only installation. In this instance, the material will provide protection from termites entering below the slab. Research indicates that the vast majority of termite entries to concrete foundations are through the gaps that penetrate floor slabs (support columns, utility pipes, floor-slab/sidewall joint). Thus, substantial protection termite entry will be gained, radon mitigation will be as good as the current standards, and there will be measure of insulation below the floor-slab. Drainage can be built-in if required, but attention must be directed to the details of the EPA Radon Mitigation guidelines (e.g., see EPA publications cited above) and drain tile installation. Several other products on the market can be used to provide termite protection on the sidewalls (Termi-mesh, Polyguard waterproofing are examples) if it is required. It has become common for builders to install rigid polystyrene insulation around and sometimes under foundations to provide an extra measure of insulation to the building foundation. It is well-known that termites love to tunnel in this rigid polystyrene material and will quickly render it useless as an insulating material once they find it. This also serves to keep termites against the structure, resulting in their eventual penetration of the foundation and infestation of the structure. Thus it is advised that rigid polystyrene insulation not be used below grade, unless it is completely protected by the aggregate barrier material.

In order for the aggregate material 10 to provide complete ventilation around the entire foundation, there preferably should be continuous contact of the under-slab and sidewall portions of aggregate. One solution for this is to place a 6″ aggregate layer 10 continuously under the footings, moving the drain tile to the lowest point of aggregate 10. Another solution is to incorporate 4″-6″ tubes into the footings with each end terminating in the aggregate layer 10, thereby connecting the air spaces within aggregate 10 on the side wall to the sub-slab layer. A further solution is to vent the sidewall and sub-slab aggregate layers separately. Local building conditions will dictate which solution is appropriate for any given structure.

Furthermore, to function as a radon mitigation device, any aggregate 10 preferably should have very low or negligible levels of radio-activity, so they do not add to the sub-slab radon levels. Tests of material 10 indicate the radioactivity is negligible, and will not add to the radon levels in the soil adjacent to a foundation.

C. Generalized Examples

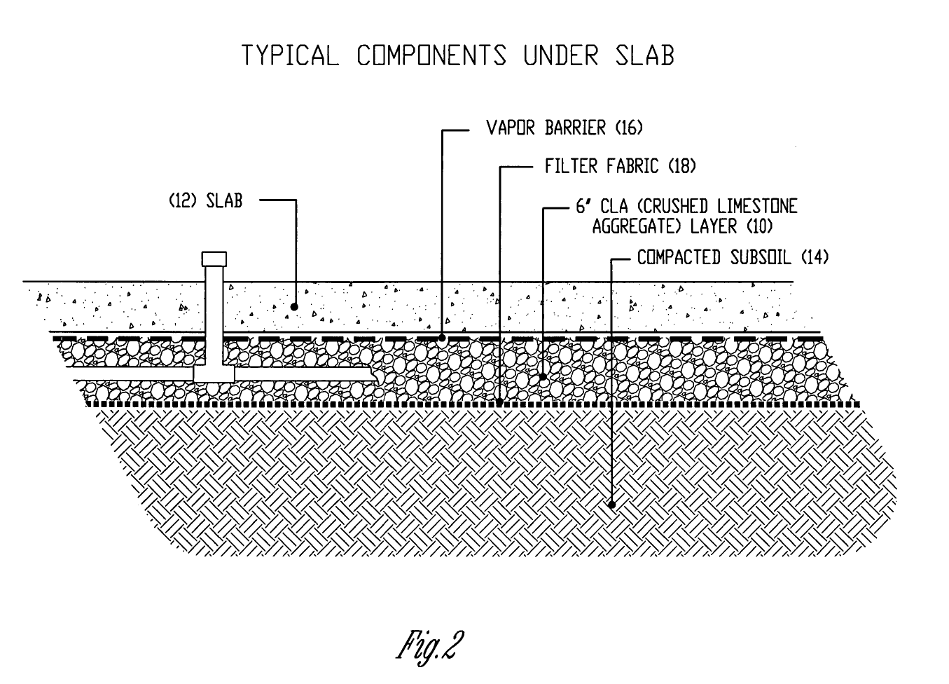

1. Below slab—FIG. 2

FIG. 2 is intended to illustrate in simplified diagrammatic fashion, one common implementation of material 10 into an under-slab construction system which includes other materials. A 6 inch layer of material 10 underneath the concrete slab 12 can serve to support slab 12 relative to sub soil 14 and provide a termite barrier. It can also provide a substantial thermal insulation factor while, at the same time, provide drainage and radon mitigation for the structure on the slab.

Variations on thickness of the layer of material 10 are possible. A minimum thickness of about 6 inches beneath a slab is required. The six inch layer provides ample voids for drainage and permeability to radon, provides a deep enough layer for any required structural support, and also provides a thick enough layer to minimize the impact of contamination on the construction site. Contamination of Basaltic Remite Barrier (“BTB”), as described in the Tamashiro patent, during construction in Hawaii has proven to be a major reason for failed installations of the termite barrier. Increasing the thickness of the material from a minimum of 4 inches to a minimum of 6 inches will increase the tolerance to contamination.

FIG. 2 indicates some options that might be used with under-slab barrier 10. First, subsoil 14 can be compacted prior to placement of the layer of material 10.

Second, a geotextile but water permeable fabric or cloth 18, or other such barrier, preferably should be laid on subsoil 14 prior to placing aggregate barrier material 10. This will prevent mixing of subsoil 14 with aggregate 10 during placement. An example of fabric 18 is a nonwoven synthetic geotextile fabric designed specifically for soil filtration purposes. The aggregate must remain clean in order to perform drainage, radon mitigation, insulation and termite barrier functions. If the interstitial spaces are clogged, these functions could be compromised.

Third, FIG. 2 also illustrates a vapor barrier 16. It can be a standard 6-10 ml poly vapor barrier to cover aggregate 10 prior to placement of concrete slab floor 12. In the EPA guidelines, the stronger or heavier weight polyethylene products are recommended due to the propensity of the larger rocks they recommend to cause punctures in the vapor barrier. The smaller sized particles comprising material 10 do not easily puncture vapor barrier materials applied on top thus allowing the use of lighter weight (lower cost) poly sheeting and reducing the number of punctures. This will allow the poly sheeting to perform much better as a barrier to radon infiltration through the slab, thus improving the performance of the system at preventing radon infiltration through the slab. Cross linked polyethylene is a much more durable product recommended by the EPA for use on larger (½″-1″) aggregate. If cross linked polyethylene sheeting is used with material 10, lighter weights (4-6 mil) will be sufficient, thus reducing the cost. The poly vapor barrier will prevent the concrete from mixing with limestone aggregate 10 and assist in maintaining an even six inch layer before the concrete is placed. It also prevents any radon gas or water from passing through the aggregate layer into the gaps in the concrete slab above. All seams between overlapping sheets of vapor barrier material should preferably be sealed to provide a constant impermeable membrane.

Therefore, using the specific combination of FIG. 2, with all options, installation steps are recommended as follows:
1. Soil compaction under slab 12.
2. Geotextile filter fabric 18 to separate aggregate 10 from subsoil 14.
3. Installation of gas collector and vent stack (as per EPA guidelines)
4. Aggregate 10 depth of minimum 6 inches.

5. Vapor barrier 16 on top of aggregate 10.
6. Concrete 12 placement.

Note the optional configuration shown at the left side of FIG. 2. A 3″ perforated drain tile covered in fabric extends around the perimeter of the basement below the slab, encompassed in 6″ of CLA on all sides. The closed loop is connected by a solid PVC T-section which extends up through the slab against the outside wall. A 3″ PVC T-section extends up through the slab, allowing for future connection of radon vent pipe and fan. A cap seals the top of the pipe if or until connected to radon vent pipe and fan.

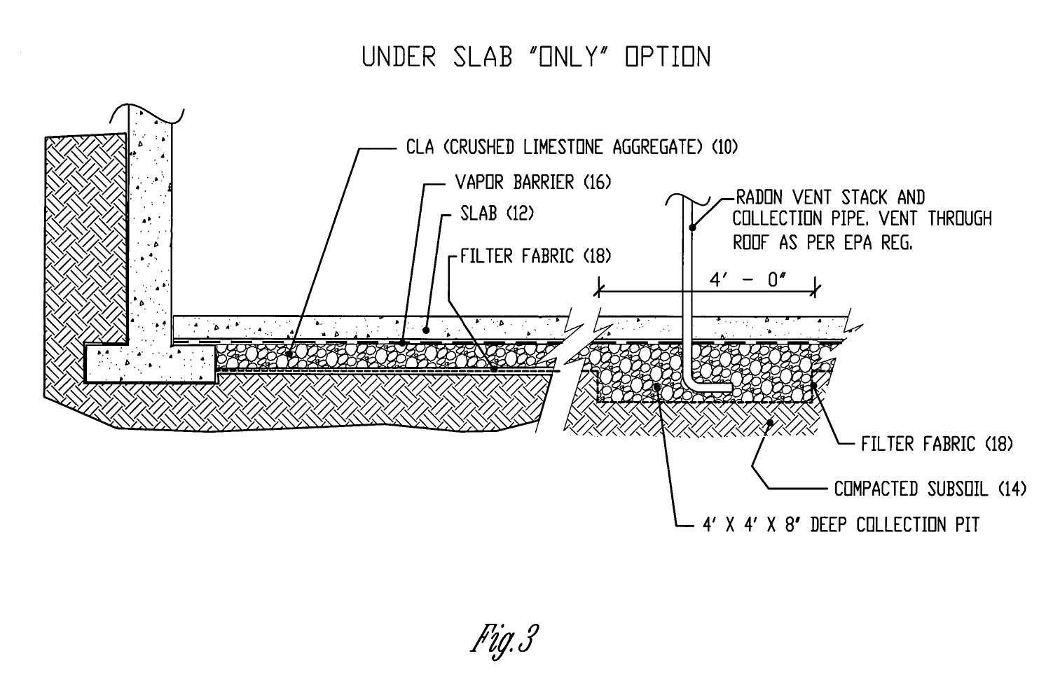

2. Side Wall—FIG. 3

In comparison to the under-slab layer 10 of FIG. 2, FIG. 3 illustrates (in simplified form) utilization of a layer of aggregate 10 along a foundational side wall 20. The width of layer 10 can vary but, again, is recommended to be 6 inches minimum. It extends from the top of side wall 20 to its bottom, including around its footing 21 (terminating generally at the horizontal level of the bottom of footing 21). It can also be placed completely under the footing if required, creating a continuous and complete layer around the entire foundation.

Layer of aggregate 10 can serve as a termite barrier. But it also can serve drainage, thermal insulation and/or radon mitigation functions. Preferably it is applied around the entire perimeter of the foundation in this manner.

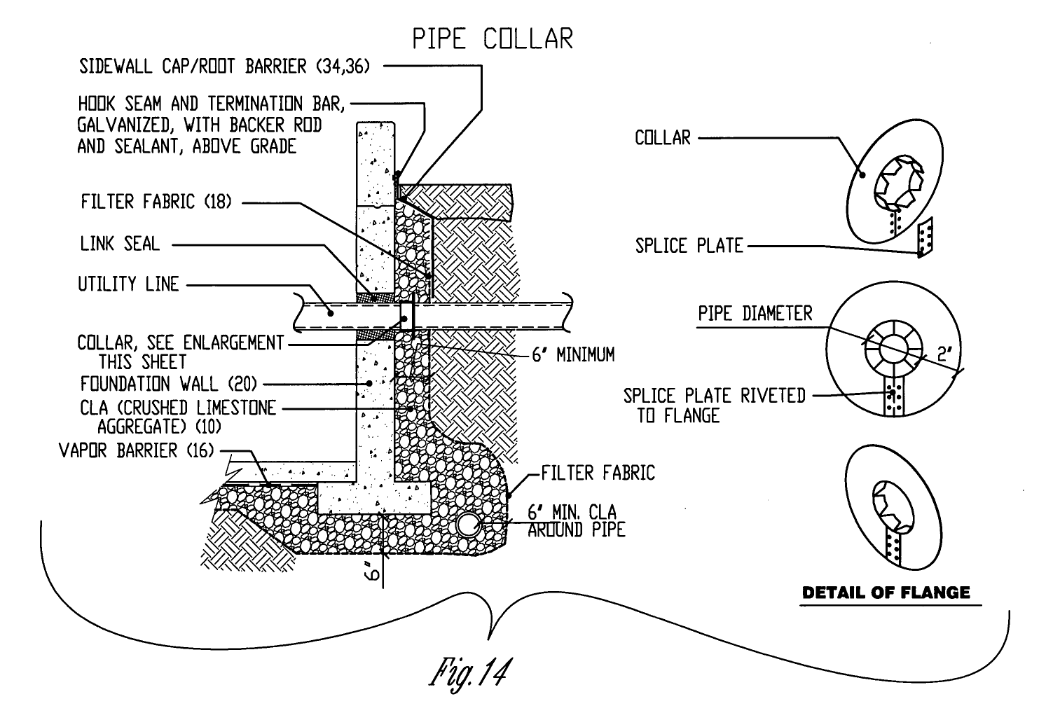

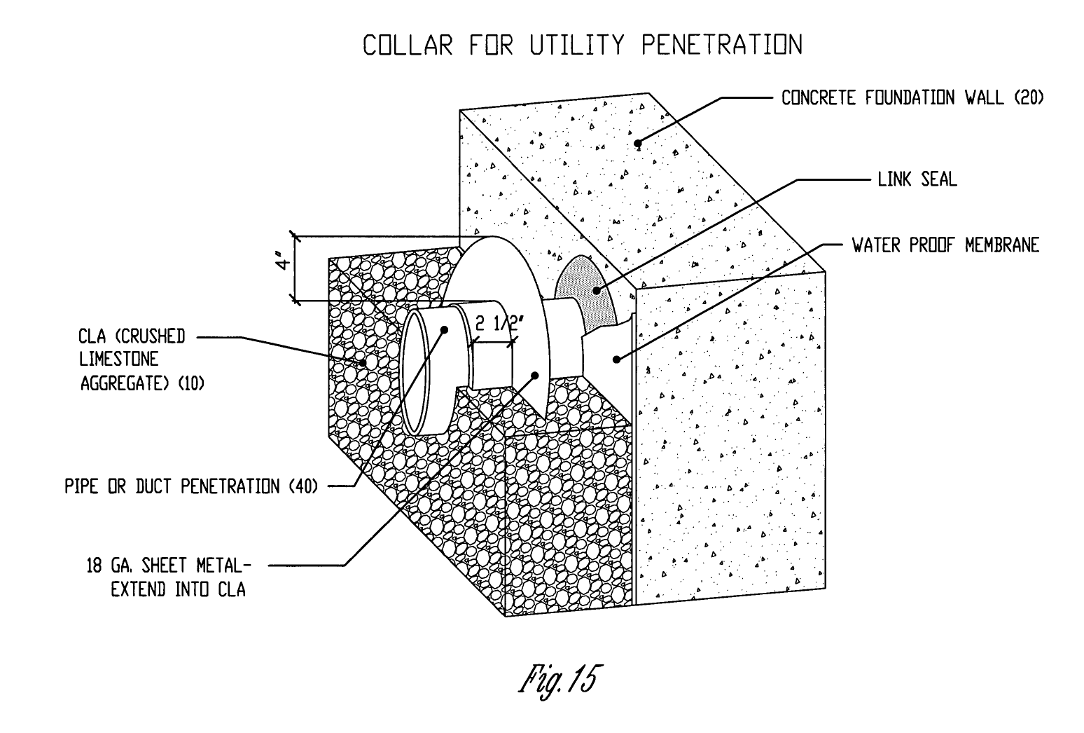

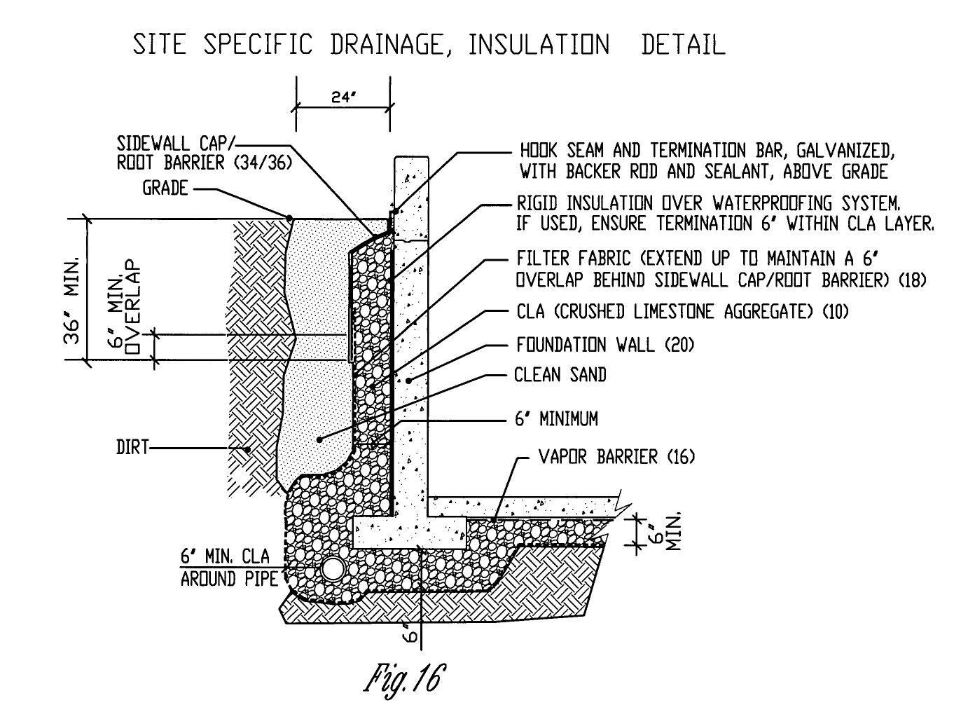

FIG. 3 shows some additional features. A drain pipe 40 can be emplaced surrounded by aggregate 10 near the footing for controlling hydraulic pressure around that part of the foundation. An example of pipe 40 is a 6″ diameter perforated drain pipe which is “socked” (covered with fabric) in order to prevent aggregate 10 from entering pipe 40 and reducing drainage capacity. (See FIGS. 14-16 for details of specific structure and installation). It is recommended there be at least 6 inches of aggregate 10 on all sides of socked drain pipe 40. Filter fabric preferably is placed on the subsoil prior to adding the first layer of material 10. The filter fabric should be brought up the outside of material 10, forming a barrier between it and the remaining backfill. Slip forms made from plywood or any other rigid material can be used to maintain the 6″ distance from the foundation wall. It is further recommended that back fill 14 and aggregate 10 be placed concurrently, with back fill 14 compacted in 2 foot lifts to settle aggregate 10 (by the transmitted vibration from the compacting of the adjacent back fill). The slip forms should be raised to the next height prior to compacting the backfill adjacent to material 10.

After placing aggregate 10 above socked drain pipe 40 filter fabric 46 is recommended to be installed at a distance from wall 20 that will allow at least a 6 inch layer of aggregate 10 to be maintained from footing to grade. These types of filter fabrics are commercially available and known in the art.

FIG. 3 also shows a combined cap/root barrier 36 that is placed along the outer-most side of the aggregate layer 10 for a distance from grade down. Root barrier 36 prevents tree and shrub roots from growing through aggregate 10 and providing a conduit for termites to access the structure. It will also reduce or prevent tunneling by other insects or animals and provide a rigid barrier to landscape crews. These types of barriers can be constructed by those skilled in the art. Alternate materials could include galvanized sheet metal, aluminum, copper, or solid (rigid) plastic sheets.

FIG. 3 shows a new design for a side wall cap 34 can be utilized that incorporates the root barrier into one piece. The cap/root barrier is to be constructed of heavy gauge galvanized sheet metal, or other material that will not degrade in the soils. The cap/root barrier is placed at the appropriate depth to allow for it to act as the separator between the remaining backfill and the material 10. The cap/root barrier is then folded over the top of the material 10 at or near grade, and attaches to a hook bar fastened to the wall 3-6″ above grade. The separate sections of sheeting used to make the cap are sealed (e.g. welding or adhesive) to provide a permanent seamless barrier. If welding is used on galvanized sheet metal re-application of a cold (spray-on) galvanizing coating or some other protective coating will be necessary to prevent corrosion. The filter fabric is to overlap the root/barrier/cap material and terminate approximately 8-10″ above the bottom edge on the inside adjacent to material 10. A cap (here at grade) on the side of a retaining wall maintains the integrity and minimizes contamination of aggregate 10 over time. It will also retain warm air escaping from the upper portion of the building foundation in winter months, and if so desired, can be fitted with active or passive vents for radon mitigation. Note that venting the cap will have an adverse effect on the insulative properties of material 10. Options for capping aggregate 10 vary according to the aesthetic and structural characteristics of the building. Such caps are not commercially available and must be fabricated. Variations on caps can be as simple as a concrete block with a fabric sheet of root barrier extending down the sidewall 2-3′, as depicted in the BTB patent of Tamashiro. It is important that the cap be above the final grade of the adjacent backfill and landscaping.

Therefore, in the embodiment of FIG. 3, primary components to a perimeter, multi-functional barrier can include:
1. Socked perforated drain pipe 40.
2. Filter fabric 46.
3. Side wall cap/root barrier 34.
4. Crushed limestone aggregate 10.

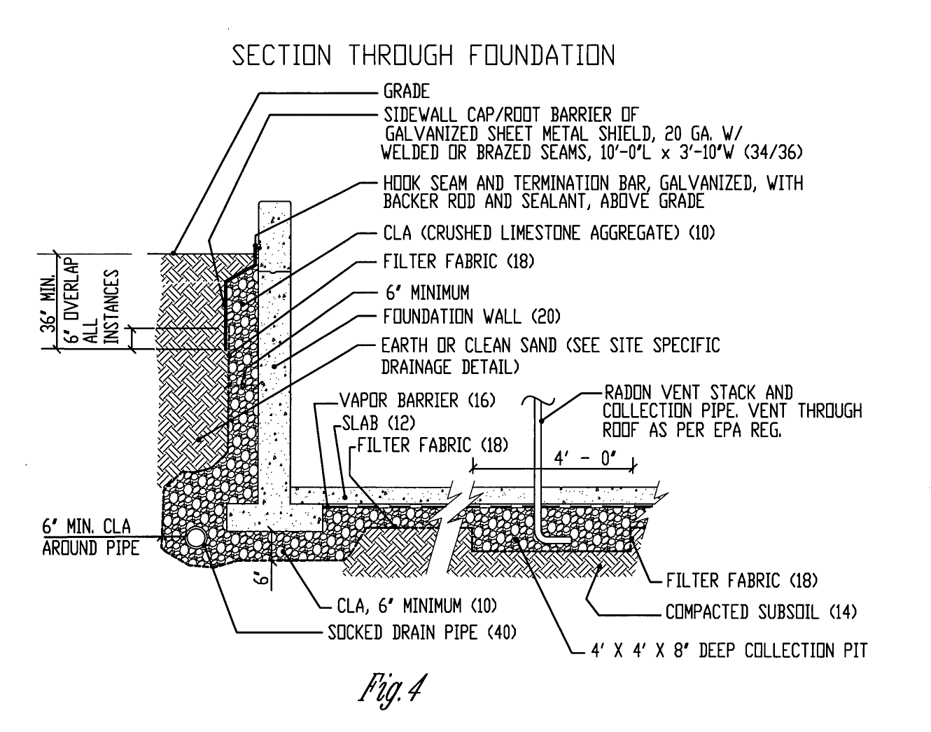

D. Specific Examples
1. FIG. 4

An under-slab barrier of the type generally described regarding FIG. 2 is illustrated in detail at FIG. 4. To the left of FIG. 4, a layer of material 10 is beneath the bottom of concrete slab portion 12A and under-lying ground 14. FIG. 4 also illustrates generally an interior wall 32 in the building supported by footings 12. Thus, like FIG. 2, material 10 provides its multi-functions for a slab structure.

Under structures and building slabs, it is recommended to compact the top 8 inches of the existing subgrade and each layer of back fill or fill material at 95% of the maximum dry density according to ASTM D 698.

Vapor barrier 16 can be according to the following description: ASTM E 1745, Class A or B, 3-ply, nylon or polyester cord reinforced, hi-density polyethylene sheet; laminated to a geotextile fiber, weighing 2.5-4 lbs/100 s.f, with perm rating less than 0.30. Seam tape should be provided by the same manufacturer. Products that are believed to be good candidates are “Moistop” by Fortifiber and “Griffolyn T-65G” by Reef Industries, Inc.

One example of layer 18 is geotextile filter fabric made from polyolefins, polyesters, or polyamides, with the following minimum properties determined according to ASTM D 4759 and referenced standard test methods:

| | |
|---|---|
| Weight: | 4-6 oz./sq. yd. |
| Grab tensile strength: | 110-130 lbf; ASTM D 4632 |
| Tear strength: | 45-60 lbf; ASTM D 4533 |
| Puncture resistance: | 60-80 lbf; ASTM D 4833 |
| Apparent opening size: | 50-70; ASTM D 4751 |

Products which are believed to perform similarly to the above requirements are Product No. 4547 from BP Amoco or Product No. 140N from Mirafi, Inc.

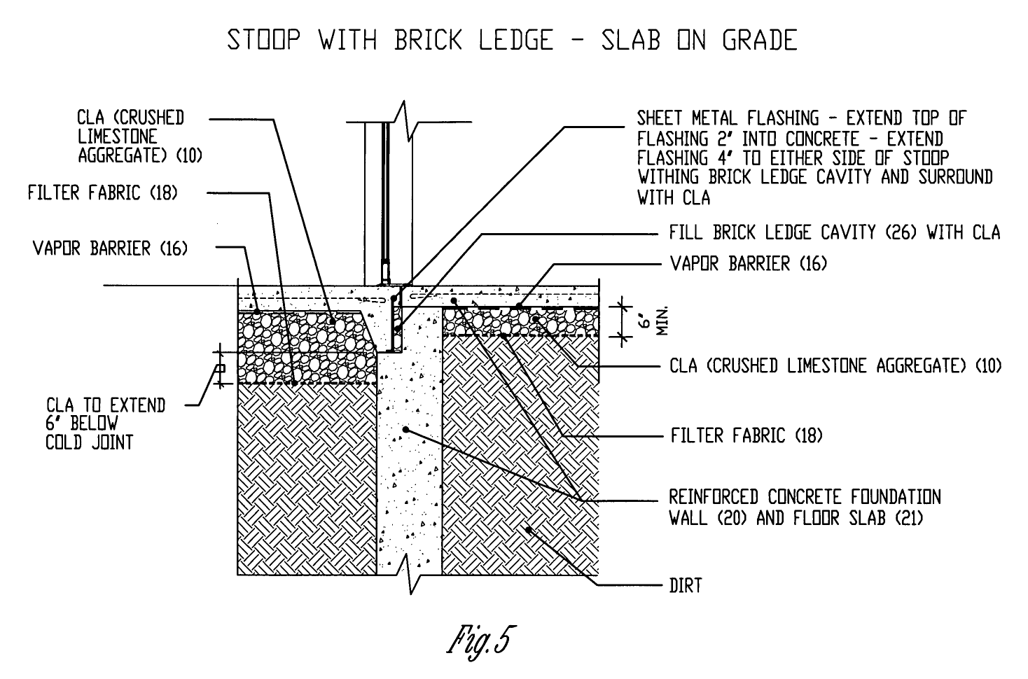

The embodiment of FIG. 5 shows some additional features. Slab 12 is supported by foundation wall 20 at upper end 22 and shoulder 24. This configuration creates a pocket (see reference numeral 26). FIG. 5 shows pocket 26 can be filled with aggregate 10. A sheet metal flashing 28 can be molded into the material 10 (protruding vertically above) and poured into the concrete stoop. It must also extend horizontally out from each side of the stoop, extending into a cavity on either side that is to be filled with material 10. Material 10 should encompass the sheet metal flashing within the cavity. This cavity is common to buildings with a brick ledge on the foundation to support the outer brick veneer of the upper portion of the structure.

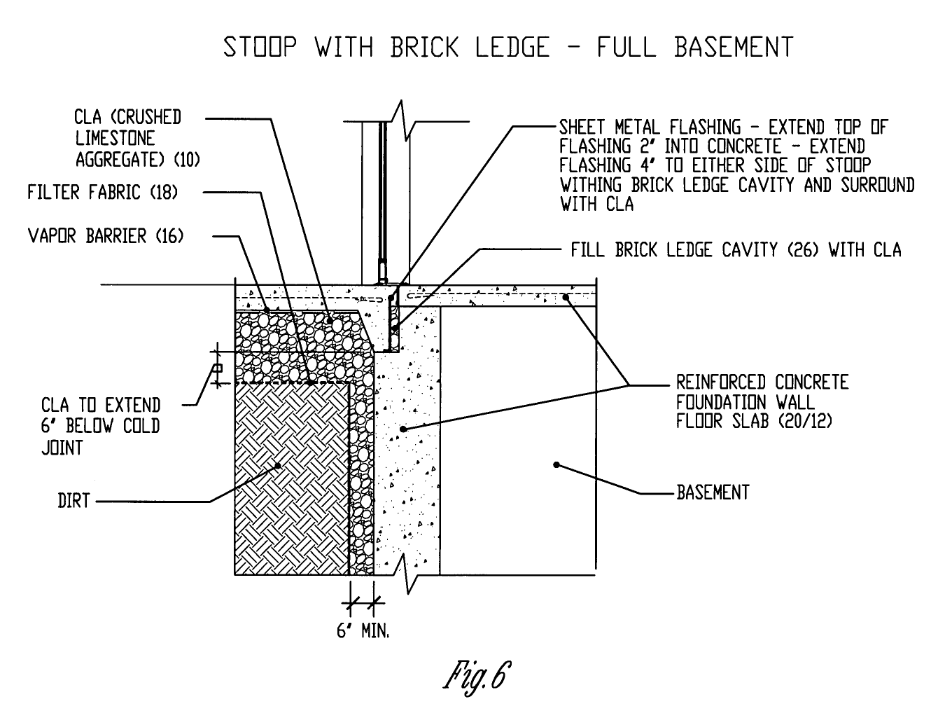

FIG. 6 shows an alternative stoop but with full basement.

Layer 10, with its multiple functions, therefore exists not only beneath all parts of slab 12, but also in the cavities such as cavity 26. This would allow for complete coverage not only as an insect barrier, but also for thermal insulation, drainage, and radon mitigation for areas between slab and soil, as well as for spaces between parts of the slab and associated foundational structure, or in voids between masonry components of the outer wall.

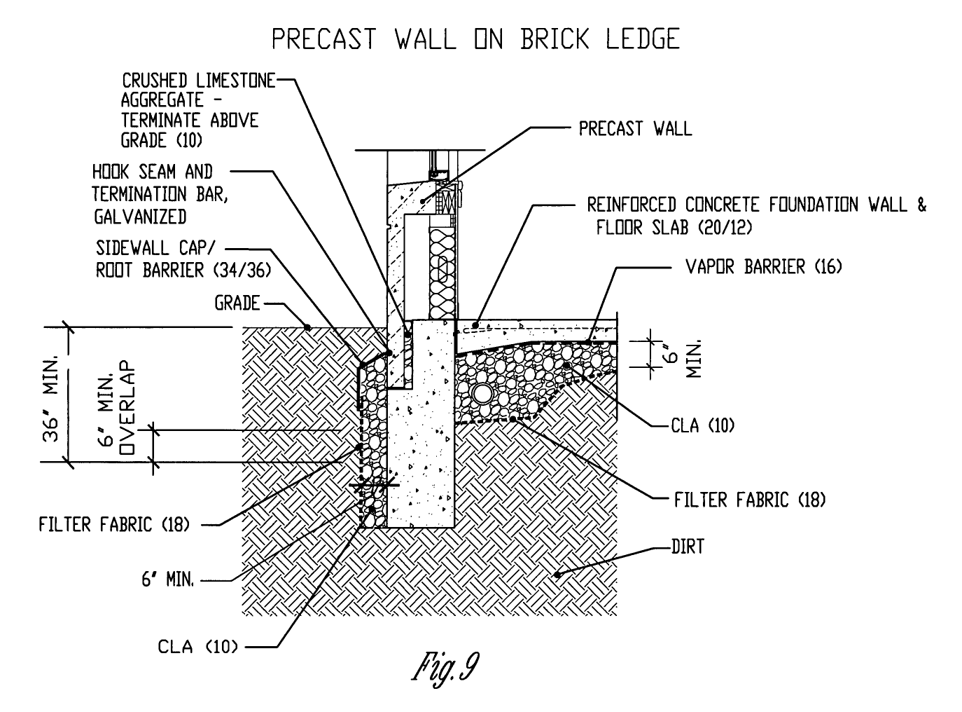

FIGS. 5, 7 and 9, illustrate this particular construction, with a cavity between the brick wall 32 and part of the side of foundation wall 20. Aggregate 10 can fill this cavity.

FIG. 3 also shows an example of aggregate 10 along a side wall. It further shows sheet metal flashing cap 34 that extends from grade down under-grade to the start of the layer of aggregate 10. Sheet metal flashing cap 34 thus would provide an impenetratable barrier to insects. It would also direct water away from the foundation wall. Furthermore, a substantial majority of the side wall would have layer 10.

As indicated, root barrier 36 and filter fabric 46 could be utilized to form a combination apparatus or system that form a a part of the overall foundation construction.

2. FIG. 5

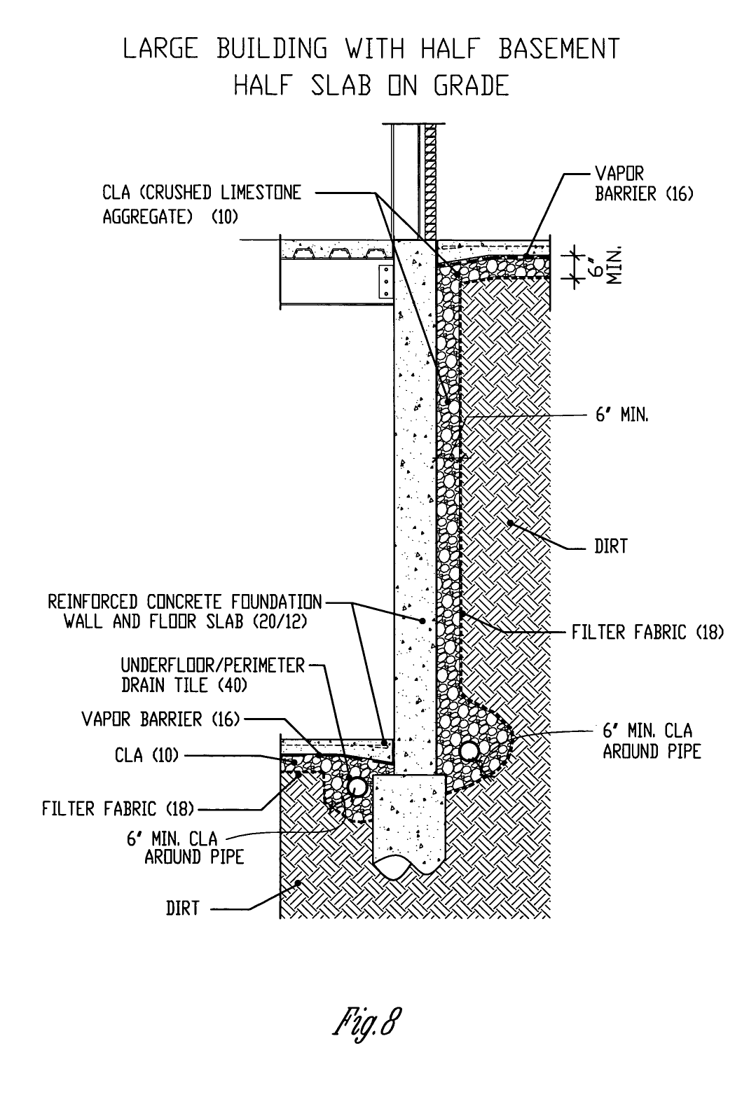

One difference from FIG. 3 is the structure at the top of layer 10. Utilization of a sheet metal shield, hook/seam termination bar, direct water away from wall 20, provide an impenetratable insect barrier, and serve to retain and place the upper end of layer 10. An enlarged view of this arrangement is shown at FIG. 8.

A filter fabric 46 is shown. If silt particles are allowed to flow into the layer of aggregate 10, over time the particle size range might be altered and termites may be able to penetrate the altered material. Further issues can arise from increased water retention against the side of the structure following excessive siltation of the aggregate material 10. Therefore, filter fabrics are required to be installed parallel to the perimeter of the foundation wall 20 on the outside of the CLA, protecting it from the immediately adjacent backfill. With the one piece cap and root barrier, the filter fabric should overlap the bottom of the root barrier by 6″ and be placed on the inside of the root barrier. With the concrete haunch cap system, the filter fabric should overlap the root barrier material completely, terminating at or above grade by being fastened to the face of the concrete with a metal or plastic termination bar.

Filter fabric 46 is a separator between aggregate 10 and regular back fill material. One example that would be recommended is a woven geotextile, specifically manufactured for use as a separation geotextile. It can be made from polyolefins, polyesters or polyamides and with the following minimum properties determined according to ASTM D 4759 and referenced standard test methods:

| | |
|---|---|
| Grab tensile strength: | 200-370 lbf; ASTM D 4632 |
| Tear strength: | 60-100 lbf; ASTM D 4533 |
| Puncture resistance: | 90-150 lbf; ASTM D 4833 |
| Waterflow rate: | 4-18 gpm per sq. ft; ASTM D 4491 |
| Apparent opening size: | 30-70; ASTM D 4751 |
| Permittivity | 1.7-1.9 sec⁻¹; ASTM D-4491 |
| Flow Rate | Minimum = 120 gal/min/sq ft |

Subject to compliance with requirements noted above, the following products are believed to work adequately: Amoco “2002” and Mirafi “FW700”.

A combined cap/root barrier has been designed for this project, as indicted in FIG. 3. Other optional root barriers are commercially available in different sizes, and can be installed starting at 1 inch above final grade to a depth of 3 feet. One example is 1 foot by 3 foot rigid polyethylene sheets which link together. Root barrier sheets also come in 1 foot by 4 feet and 2 feet by 2 feet panels. The sheets are relatively rigid. One specific example is a geosynthetic material made of homopolymer polyethylene of 0.080 inches (2.032 mm) thickness designed specifically for root/weed control. Panel dimensions are UB 36-2; e.g. 36 inches height by 24 inches width (91.5 centimeters by 61 centimeters). The following minimum properties are recommended:

| | |
|---|---|
| Tensile stress at yield: | 3800 psi; ASTM D 638 |
| Elongation at break percentage: | 10%; ASTM D 63 8 |
| Tensile modulus: | 155,000 psi; ASTM D 638 |
| Notched izod impact: | 0.4-4.0; ASTM D 256A |
| Flexural modulus: | 73 psi; 145,000; ASTM D 790 |
| Hardness shore: | P66; ASTM D 2240 |

One example of a commercially available material is Deep Root “UB36-2” for a 3 foot deep barrier.

A second example is geotextile sheet root barriers, with root inhibiting chemical nodules built into the fabric. An example of this product is Biobarrier® by REEMAY.

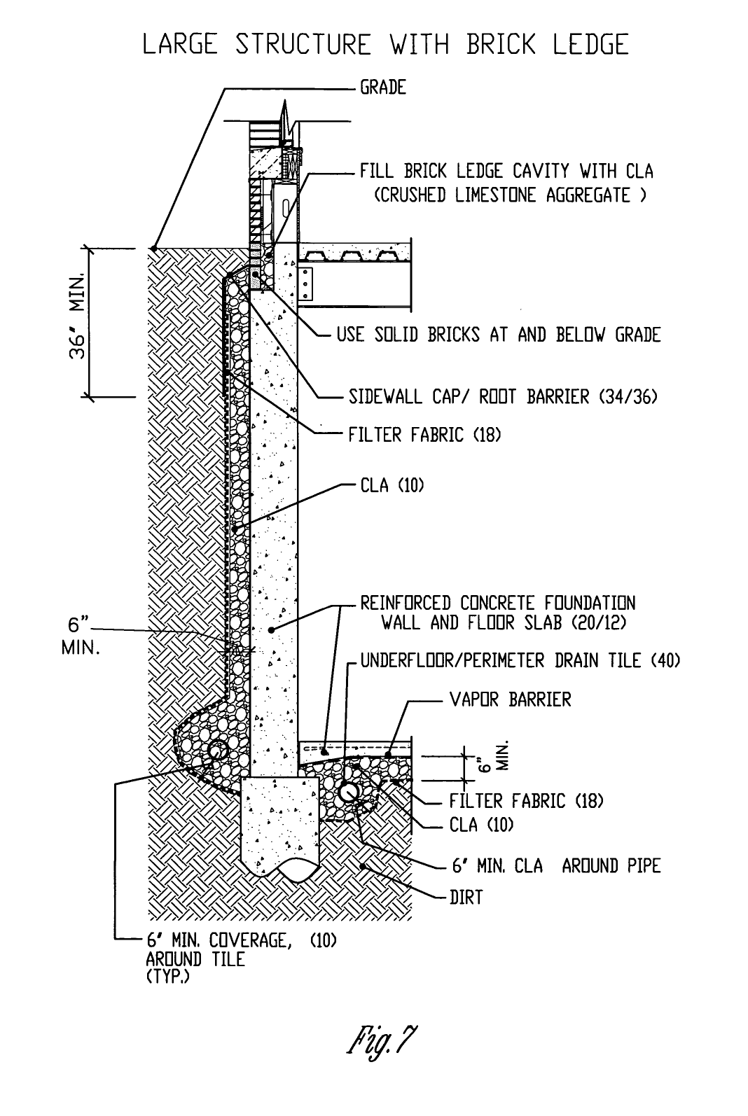

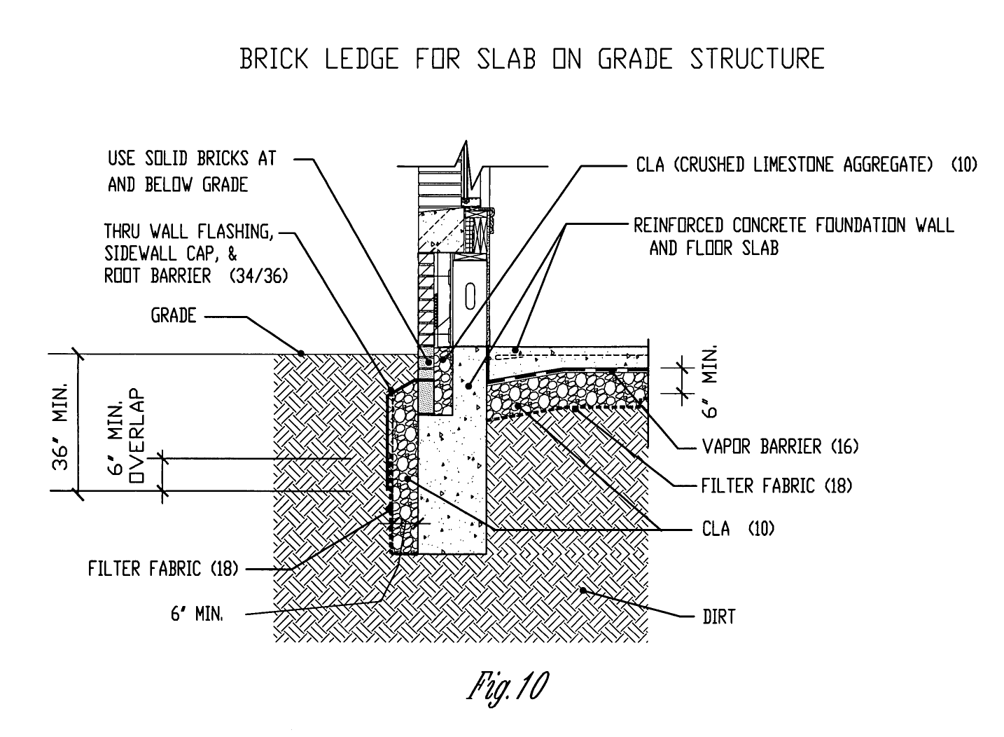

FIG. 7 shows, in detail, side wall cap 34. Aggregate barrier 10 is capped at grade on the side of retaining wall 20 to maintain its integrity and minimize contamination over time. FIGS. 7 and 10 show one option of side wall cap 34, namely a metal flashing or plastic (PVC or polyamide) sheet which is preferred for cap 34 on buildings with block or brick facing. The sheet is installed as a through-wall flashing, or tooled into the wall just above grade (1-3 inches). (If it is installed below grade, the void space between the brick veneer and concrete (brick ledge) must be filled with CLA to a point at least 1 inch above grade.) The flashing extends at a 30-45 degree angle from horizontal down into the soil covering the top of crushed limestone aggregate 10. Then it extends horizontally to a depth of 3′ below grade, providing the root barrier function. This embodiment covers the entire 6 inch wide span of aggregate 10. Cap 34 is preferably complete around the building perimeter. Any gaps at joints or other locations should be overlapped and completely sealed. Such a cap is expected to last 30-50 years without degrading and should be repairable if punctured or damaged. Cap can be at or below grade, or partially above grade. It can minimize contamination of and water infiltration into material 10.

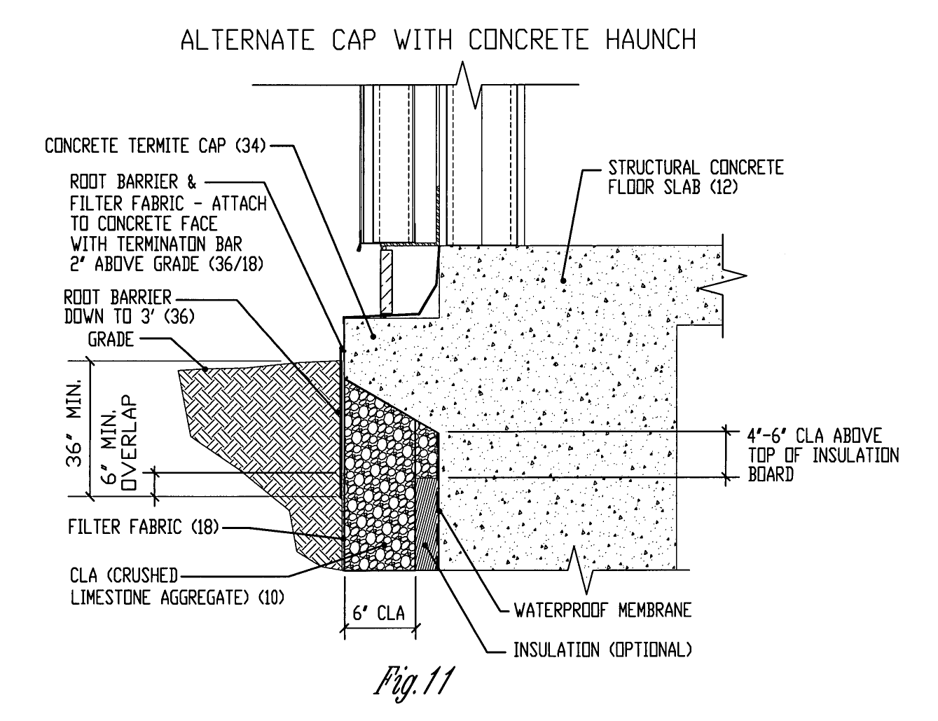

3. FIG. 11

Another cap embodiment is shown in FIG. 11. With concrete foundations, a 6 inch overhang (45 degree angle) or haunch cap can be incorporated into the concrete wall just above grade. Aggregate 10 is brought up to height under the overhang, and the root barrier and filter fabric are attached to the face of the haunch at or up to 2″ above grade. The root barrier material in this option can be solid hard plastic or PVC sheets, sheet metal, or flexible geotextile fabric impregnated with nodules of root inhibiting chemical (e.g., Biobarrier by REEMAY).

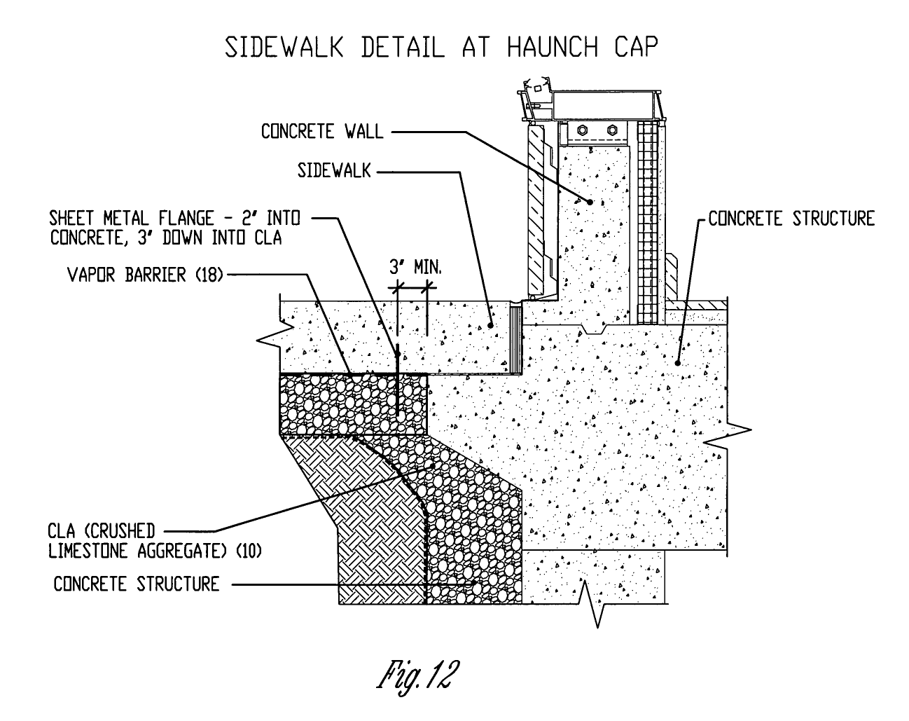

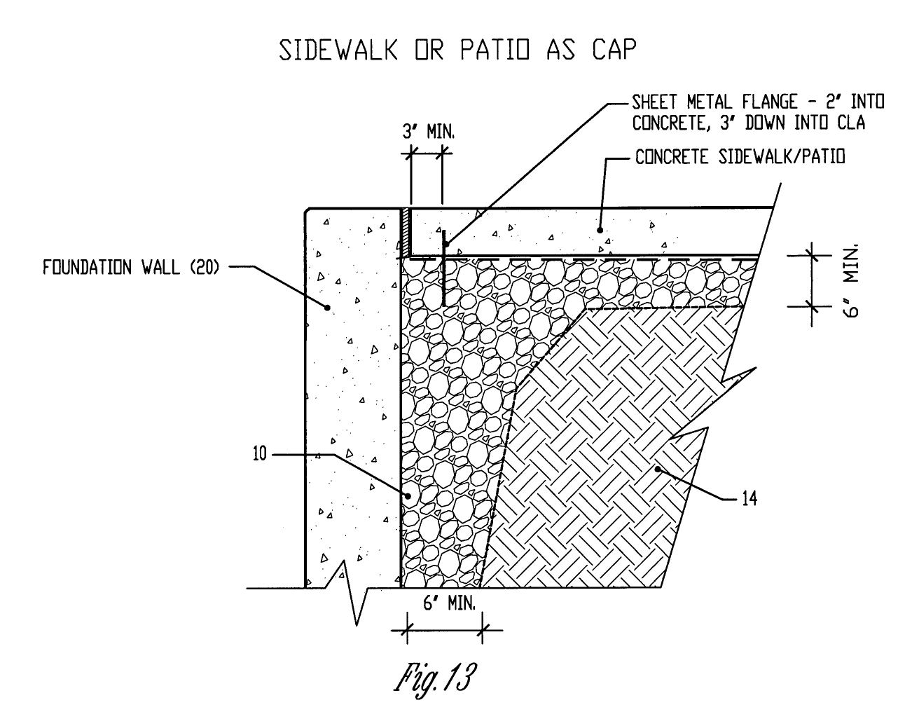

4. FIGS. 12 and 13

A still further cap detail is shown in FIG. 11. In locations where a concrete sidewalk, stoop, patio or other landscape is butted up against the side of the foundation with or without the haunch cap, the material shown in FIGS. 12 and 13 becomes the cap for the side wall barrier. In these locations a continuous piece of metal flashing is inserted vertically into the surface of the aggregate 10 to a depth of 4 inches, with 2 inches remaining exposed above grade. It is recommended to place the concrete directly on top of aggregate 10 and the exposed 2 inches of flashing. This will force any termites walking along the bottom of the concrete sidewalk back into aggregate 10. The reason for the flashing is that the aggregate may slump 1-2 mm over time, pulling away from the underside of the concrete above. This tiny gap is enough to provide termites a direct path to the building along the underside of the slab, above the aggregate barrier.

5. FIG. 10

A different installation of the cap/root barrier is shown in FIG. 10. In structures utilizing brick veneer on a concrete foundation where the grade is sloped and the lower course of bricks are below grade on part of the structure, the embodiment of FIGS. 7, 9 and 10 can be used. The bottom courses of brick are preferably solid. The void between the brick and the brick ledge on the concrete foundation can be filled with aggregate 10. Through-wall metal flashing or PVC is then installed in the lower brick course extending out and over the aggregate 10, providing a cap that will remain below grade on the structure.

E. Installation Methods

As can be appreciated, a variety of methods can be used to install the multi-function system of the present invention. However, the following installation steps are believed preferable:
a) Install a layer of material 10 just before placement of concrete slab 12 after all plumbing and utility work have been completed.
b) Aggregate 10 should remain completely clean. Contamination by other materials, e.g. debris, mud, etc., may alter the ratio of particle sizes and degrade termite barrier function.
c) One application method found to work well is using a conveyor truck with a sock for directing placement of material 10. Dumping material 10 on site and using a skid loader to place the material likely will increase breakdown of particles of material 10 and allow further opportunity for contamination. Preferably, it should not be stored on site but rather delivered and placed directly.
d) If a skid loader or other type of loader is used for placement, preferably it should be dedicated to working within only material 10 rather than other earth work to prevent contamination by other materials.
e) Preferably the aggregate 10 should be vibrated to settle it around any penetrations through slab 12 such as those for utilities, support columns, or drainage. Vibrating is also recommended along the edges of the footings. Vibration helps settle the aggregate, which is believed advantageous for most of its multiple functions.
f) Preferably avoid use of grade pins for leveling slab 12. If grade pins are used, it is recommended they be removed (not driven down) prior to placing slab 12. Mark all elevations and foundation walls or columns. Minimize penetration through slab 12 and material 10.
g) It is best if material 10 remains dry until it is covered by concrete or installed. For very large floor areas that will have a substantial delay between placing of separate sections of concrete, it is advisable to place a 2 inch concrete slab (mud-slab) on top of aggregate 10 in order to get it covered and protected, allowing for further construction work to continue.
h) To avoid contamination material 10 should not be stored on site. It is best to have it delivered and placed immediately. If on site storage is unavoidable, a plan for delivery storage and handling should be made. A specific storage bin should preferably be provided and kept free of construction debris to avoid contaminating the aggregate.
i) If there is a time lag between installing aggregate and placing concrete slab or capping, a plan to protect the aggregate from contamination should be made.
j) Ensure aggregate flows completely around all utility and pipe penetrations in as tight against the edges of footings. Vibrating in these locations will assist settling.
k) The aggregate material should always be placed in a layer at least approximately 6 inches thick at all locations, including under the slab and against the side walls from the base of the footing to grade. Preferably the entire foundation is encapsulated.
l) All synthetic materials used on the foundation, such as waterproofing membranes or polystyrene installation, should be completely covered by at least 6 inches of aggregate. No synthetic materials that touch the foundation wall should penetrate out past or through the aggregate to contact the surrounding soil.

It is strongly recommended that the use of polystyrene insulation on the exterior of the foundation be completely avoided.
m) If possible, avoid using grade pins. If grade pins are used they must be removed completely, not driven down below the slab.
n) If Formadrain product, or a similar product, is used to form the footings, do not use wooden stakes to hold the Formadrain in place. Note that Formadrain must sit below the level of the aggregate. Thus, a 12 inch footing will be required with Formadrain on the bottom and the top 6 inches formed with wood. All wood forms must be stripped and removed.
o) It is recommended that if the aggregate barrier is placed under-slab and along side wall, it be done in two separate phases, under-slab first and then side wall barrier.
p) A galvanized sheet metal or aluminum pipe flange and collar should completely seal around the pipe or utility penetrations through the aggregate side wall and concrete foundation. The collar should be placed at the 4 inch mark away from the foundation, with remaining 2 inches within the aggregate. The flange and the collar should extend out from the pipe at 90 degrees and penetrate into the surrounding aggregate to a depth of 2 inches. A plastic/insecticide commercial product that will work well for this application on pipes up to 4″ in diameter is the IMPASSE BLOCKER by Syngenta. Slumping or settling of the aggregate away from the bottom tangent of the pipe (even 1-2 mm) will allow foraging termites to move along the bottom of the pipe to the foundation wall. The collar is intended to force termites moving along the pipe back into the aggregate, thus preventing them from accessing the wall.
q) Avoid using screed sticks for leveling slab. These will provide a direct conduit for termites through the termite barrier and slab.
r) In perimeter barriers, place 6 inches depth of aggregate and cover it by filter fabric below any drainage pipe.
s) Place socked or fabric coated perforated drain pipe in order to prevent aggregate from going into the pipe. Surround the drain pipe with aggregate to a thickness of 6 inches on all sides.
t) Place the back fill after placement of aggregate every foot in height up the side wall.
u) Install slip forms at a distance of 6″ from the wall foundation with the filter fabric on the side facing the foundation.

Move slip forms prior to compacting each lift of backfill.

F. Features, Options, and Alternatives

It will be appreciated that the present invention can take many forms and embodiments. Variations obvious to those skilled in the art will be included within the invention, which is not limited by the exemplary embodiments described herein. The invention is solely limited by the claims appended hereto. Alternatives and variations obvious to those skilled in the art will be included within the scope and spirit of the invention.

For example, although shown as completely encasing or surrounding the perimeter or subsurface of a foundation or slab, aggregate 10 can be used as a spot barrier where needed.

By further example, since aggregate 10 is non-chemical, it does not kill termites, but merely provides a barrier to their tunneling. It can not be used with liquid insecticides as it is part of the drainage system that connects to the storm sewer system. However, termite baiting systems are very compatible with this physical barrier system. Bait stations should not be installed into the aggregate layer, but rather in the dirt near the aggregate layer. Bait stations are recommended for eliminating termite colonies adjacent to structures that utilize this physical barrier system.

Furthermore, it is to be understood that the characteristics of aggregate 10 may replace or obviate the need for other construction materials. For example, larger aggregates or tiling for drainage may not be required. Polystyrene boards for insulation may not be required. It may even be possible that the function of a pressurized radon mitigation system may be included.

As indicated previously, the precise range of particle size for aggregate 10 can vary somewhat. Tamashiro (BTB) states in his patent that approximately 40, 45, 50, 60 and 65% of the particles (by weight) should be between 1.7 mm and 2.4 mm in size (screen 8 and screen 12 respectively). Samples of material 10 indicate a range of 40-45% of the particles are in the stated size range.

TABLE 5
Required Gradation of BTB and Sample Gradation of CLA#2

| Screen | % Passing | % Passing |
|---|---|---|
| size | BTB | CLA#2 |
| 4 | 100 | 100 |
| 5 | | 98 |
| 6 | | 95 |
| 7 | | 78.5 |
| 8 | 95-100 | 61.6 |
| 10 | 75-95 | 44.4 |
| 12 | 35-50 | 31.7 |
| 14 | | 16.5 |
| 16 | 0-10 | 8.4 |
| 18 | | 4.1 |
| 200 | | ≦2.0 |

A similar comparison can be made to CLA#4 (see FIG. 1B and Table 4B).

In particular, if barrier 10 is needed for its termite barrier function, a slight adjustment of either or both ends of the discussed range of particle size may be indicated. The exact proportion of particle sizes for the entire aggregate can vary somewhat. The adjustments can be made by empirical testing. However, the particle size distribution for CLA has been pushed to the large end of the range in order to improve the construction functions of drainage, radon mitigation and insulation, while retaining the termite barrier qualities. The particle sizes are very close to the requirements of BTB for preventing tunneling by the Formosan subterranean termite. Because the material is very well graded and skewed to the larger particle sizes, it should prevent tunneling by the Formosan termite.

Selection of options is also within the skill of those skilled in the art. For example, a filter fabric can take on various forms and embodiments.

The side wall cap likely will vary according to specific construction style of each building. In some cases the cap will be incorporated right into the concrete foundation wall, while in others it may be in a sidewalk or patio. In some cases there will need to be a cap that is partially above grade along the side wall of the structure. Metal flashing or plastic (PVC or polyamide) sheet can be used to cap the aggregate barrier at grade on the side of exterior walls. This will maintain the integrity of the aggregate by minimizing contamination and water infiltration over time. Termination walls made from galvanized metal decking material (gauge 0.20) can be used to hold the vertical profile of material 10 in place on sidewalls where necessary. This need may arise due to intermittent rates of backfilling around a foundation, leading to backfill at various heights. If the CLA is not contained after it is installed, it will flow down slope. Another case for termination walls would be on either side of pipe penetrations to facilitate future renovation or repair. This will keep the CLA on either side of the pipe penetration intact when the backfill is excavated to allow repair. Clean CLA and new pipe collars can be replaced when the pipe renovation is complete.

Temporary termination walls can be used to support vertical installations of CLA along sidewalls, where only a portion of the wall is installed at one time. This situation leaves the CLA along the sidewall at two different heights for a portion of the time, until the entire wall is brought up to equal height at finished grade. Termination walls can be made from metal roofing material or solid sheeting of any sort. Dimensions of examples of such metal sheets are 1 foot by 6 feet or 2 feet by 6 feet. Dimensions of the termination wall, may change depending upon structural details.

Socked perforated drain pipes can be double wall rigid pipe with smooth interior and corrugated exterior (socked by a protective wrap (sock) fabric), gasket or snap-on joints, slotted perforations, and a stiffness of 46-40 pii per ASTM D 2412 (see FIGS. 14, 15 and 16). Wide-sweep elbows are recommended to facilitate cleaning if it will be required. One example is ASTM F 405 PVC pipe, perforated tubing with protective wrap (sock) by Advanced Drainage Systems, Inc.

As mentioned, installation methods may vary. Some recommendations and preferences for installation have been described above. But it is to be understood and appreciated that other variations in installation methods are possible and may be preferable depending on factors that are experienced or required for a particular installation. However, it is recommended that proper installation of the material 10 is crucial to the success of the system. For example, it is recommended the site be rigorously cleaned of construction debris prior to application of aggregate 10. Back fill and aggregate 10 should be placed in a non-interrupted process. Leaving sections of aggregate 10 partially installed could result in contamination. Since all contaminants are preferably initially removed, the result of leaving aggregate 10 uncovered for a time after installation is an increase in labor costs and a decrease in the quality and/or efficiency of barrier 10.

It could therefore be understood that material 10 is engineered to be multi-functional. For example, particle size is manipulated to optimize drainage properties, yet particle size is engineered to provide a termite barrier according to the species indicated for the area. Engineering can eliminate need for materials currently used for drainage and insulation (e.g., synthetic drainage matting, large one inch rock, extruded polystyrene).

It is preferable to place the back fill in aggregate concurrently up to the last 2.5 feet of the wall below grade. Start to install root barriers on the side wall 3 feet down from grade. Filter fabric is to be overlapped with the bottom edge of the root barrier by 6-8″. Preferably attach side wall cap/root barrier just above the grade level to protect aggregate at the surface. If cap must be below grade, see FIGS. 7, 9 and 10 for specific instructions.

Quality control is critical during the installation process. Close communication between contractor, project engineer and an authority on the type of insects at the construction location, will be preferred. Contractor and crew training is recommended, as are inspections during installation.

Instead of fabric filter to prevent contamination of material 10, other material or method could be used. For example, similarly sized (or larger sized) aggregate could be placed in a layer next to material 10 to hold the particles of material 10 in and deter contamination of material 10. If larger, they should not be so large as to allow penetration or passage of smaller contaminating particles (e.g. water-borne silt).

Other material or method that produce analogous functions for other components mentioned herein could be used, if deemed appropriate.

1. A construction material for use around in-ground structures comprising:
a. particles each comprising the following characteristics:
i. granular of non-regular shape;
ii. relatively hard;
iii. non-cohesive;
iv. resistant to fracture;
v. relatively low thermal conductivity;
b. the particles, when placed together collectively, comprising the following characteristics:
i. a substantial majority of a size ranging between approximately 1.0 and 3.35 mm in largest dimension;
ii. drainage properties;
iii. structural support properties:
iv. relatively permeable to liquids and gases even when settled or compacted.

2. The construction material of claim 1 wherein the particles comprise limestone aggregate.

3. The construction material of claim 2 wherein the limestone aggregate is Iowa State DOT certified 3i interstate mainline highway concrete aggregate.

4. The construction material of claim 1 wherein the particles comprise any stone material meeting hardness, specific gravity, porosity, durability, free void space, gradation, and negligible radioactivity of limestone aggregate similar to Iowa State DOT certified 3i interstate mainline highway aggregate.

5. The construction material of claim 1 wherein the substantial majority is greater than or equal to approximately 88%.

6. The construction material of claim 1 wherein the particles comprise fines and dust (≦screen 200) of less than or equal to approximately 2.0%.

7. The construction material of claim 1 wherein greater than or equal to 95% of the particles pass through a sieve size no. 5 (4.0 mm).

8. The construction material of claim 1 wherein less than or equal to 7% of the particles pass through sieve size no. 18 (1.00 mm).

9. The construction material of claim 2 wherein the limestone aggregate has physical properties like those of limestone from stone beds registered by the Iowa State DOT for 3i concrete aggregate, wherein the aggregate resists fracture under loads on the order of 400 kPa-1600 kPa, and has a Mohs Hardness scale of approximately 3.5.

10. The construction material of claim 2 wherein the limestone aggregate has a specific gravity on the order of 2.65-2.7, a % absorption on the order of 1.14, and an LA abrasion % loss on the order of 30.

11. The construction material of claim 1 wherein the construction material is adapted for use for one or more of the following relative to a structure:
a. a termite barrier;
b. radon mitigation;
c. drainage;
d. thermal insulation.

12. The construction material of claim 1 emplaced adjacent at least a portion of said in-ground structure.

13. The construction material of claim 12 wherein the in-ground structure comprises one or more of a generally horizontal slab and a generally vertical foundation wall or footing.

14. The construction material of claim 13 emplaced underneath a said slab between the slab and the ground.

15. The construction material of claim 13 emplaced along said foundation wall and/or footing, between the foundation and/or wall and the ground.

16. The construction material of claim 1 wherein the structure comprises cavities or gaps between portions of structure in ground and the construction material is emplaced in a said cavity or gap.

17. The construction material of claim 1 further comprising a barrier between the particles and the structure.

18. The construction material of claim 17 wherein the barrier comprises a vapor barrier.

19. The construction material of claim 17 wherein the barrier is a board or panel adapted for placement between the particles and the structure.

20. The construction material of claim 1 further comprising a barrier between the particles and the ground, or in the particles.

21. The construction material of claim 20 wherein the barrier comprises a heavy poly or geotextile sheeting.

22. The construction material of claim 20 wherein the barrier is a root barrier to deter plant roots from penetrating into the particles.

23. The construction material of claim 20 wherein the barrier comprises a geotextile or filter fabric.

24. The construction material of claim 20 wherein the barrier comprises a fluid impermeable cap between the particles and grade to maintain integrity and minimize contamination over time.

25. The construction material of claim 20 wherein the barrier comprises a termination wall.

26. The construction material of claim 20 wherein the barrier comprises a collar or flange adapted for placement around objects which penetrate into or through the particles.

27. The construction material of claim 1 further comprising a member extending through at least a portion of the particles.

28. The construction material of claim 27 wherein the member comprises a perforated member such as pipe or tiling.

29. The construction material of claim 28 wherein the perforated member is socked.

30. The construction material of claim 1 further comprising compacted ground adjacent the particles.

31. The construction material of claim 1 wherein collectively, the particles have an R factor on the order of 5 for every 7 inches of thickness.

32. A construction material for use around in-ground structures comprising:
a. particles comprising limestone aggregate; and
b. the limestone aggregate having a substantial majority in a particle size range of approximately between 1.0 and 4.0 mm in largest dimension.

33. The construction material of claim 32 wherein the limestone aggregate is a durable grade.

34. The construction material of claim 32 wherein the substantial majority of particles is greater than or equal to approximately 88%.

35. The construction material of claim 32 wherein the particles comprise fines and dust of less than or equal to approximately 2%.

36. The construction material of claim 32 wherein greater than or equal to 95% of the particles pass through a sieve size no. 5 (4.0 mm).

37. The construction material of claim 32 wherein less than or equal to 7% of the particles pass through sieve size no. 18 (1.00 mm).

38. The construction material of claim 32 wherein the construction material is adapted for use for one or more of the following relative a structure:
a. a termite barrier;
b. radon mitigation;
c. drainage;
d. thermal insulation.

39. The construction material of claim 32 emplaced adjacent at least a portion of said in-ground structure.

40. The construction material of claim 32 wherein the in-ground structure comprises one or more of a generally horizontal slab and a generally vertical foundation wall or footing.

41. The construction material of claim 32 further comprising one or more barriers between the particles and the structure or the ground.

42. The construction material of claim 41 wherein the barrier is selected from the set comprising a vapor barrier, a geotextile barrier, a filter fabric, a root barrier, a cap, and a termination wall, a collar, a flange, a back fill, and a board or panel.

43. The construction material of claim 32 further comprising compacted ground adjacent the particles.

44. A method of constructing a structure having at least a portion in-ground comprising:
a. placing adjacent to at least some of the in-ground portion of the structure a layer of particles;
b. the particles each comprising the following characteristics:
i. granular of non-regular shape;
ii. relatively hard;
iii. non-cohesive;
iv. resistant to fracture on the order of 400 kPa-1600 kPa;
v. relatively low thermal conductivity;
c. the particles, when placed together collectively, comprising the following characteristics:
i. a substantial majority in a size range approximately between 1.0 and 4.0 mm in largest dimension;
ii. relatively hard to compact, but settle well; and
iii. relatively highly permeable to liquids and gases even when settled.

45. The method of claim 44 wherein the particles comprise limestone aggregate.

46. The method of claim 45 wherein the limestone aggregate is a durable grade with physical properties like those of limestone certified by the Iowa State DOT for 3i mainline interstate highway concrete stone.

47. The method of claim 45 wherein the limestone aggregate is from crushed and screened limestone.

48. The method of claim 44 wherein the particles comprise stone having characteristics similar to the limestone aggregate similar to that certified by the Iowa State DOT for 3i mainline interstate highway concrete stone.

49. The method of claim 44 wherein the substantial majority of particles is greater than or equal to approximately 88%.

50. The method of claim 44 wherein the particles comprise fines and dust of less than or equal to approximately 2%.

51. The method of claim 44 wherein greater than or equal to 95% of the particles pass through a sieve size no. 5 (4.0 mm).

52. The method of claim 44 wherein less than or equal to 7% of the particles pass through sieve size no. 18 (1.00 mm).

53. The method of claim 44 wherein the particles settle well.

54. The method of claim 44 wherein the particles settle well with vibration.

55. The method of claim 44 further comprising, using the layer for one or more of the following functions relative a structure:
a. a termite barrier;
b. radon mitigation;
c. drainage;
d. thermal insulation.

56. The method of claim 44 wherein the layer is emplaced adjacent at least a portion of said in-ground structure.

57. The method of claim 56 wherein the in-ground structure comprises one or more of a generally horizontal slab and a generally vertical foundation wall or footing.

58. The method of claim 57 wherein the layer is emplaced underneath a said slab between the slab and the ground.

59. The method of claim 57 wherein the layer is emplaced along said foundation wall and/or footing, between the foundation and/or wall and the ground.

60. The method of claim 56 wherein the structure comprises cavities or gaps between portions of structure in ground and the construction material is emplaced in a said cavity or gap.

61. The method of claim 44 further comprising placing a barrier between the particles and the structure.

62. The method of claim 44 further comprising a barrier between the particles and the ground.

63. The method of claim 62 wherein the barrier is a layer of material between the particles and the ground, the layer having particle sizes generally larger than interstitial paces of the particles, to resist contamination of the particles with either the material of the layer or the soil.

64. The method of claim 62 wherein the barrier is adapted to prevent contamination and water filtration into the particles from above.

65. The method of claim 57 further comprising the steps of:
a. compacting soil under the location of the slab;
b. placing a geotextile filter fabric over the compacted soil;
c. placing the layer over the fabric to a depth of approximately at least six inches;
d. placing a vapor barrier over the layer;
e. placing a collector pipe and vent stack for radon gas flow;
f. pouring the slab over the vapor barrier.

66. The method of claim 57 wherein the particles are clean and dry before placement.

67. The method of claim 57 further comprising avoiding penetration of any item into the layer.

68. The method of claim 57 further comprising:
a. placing the layer along the wall from the bottom or footing of the wall a first distance vertically;
b. cover the layer with filter fabric approximately the first distance;
c. place a drain pipe in the layer;
d. sock the drain pipe;
e. surround the drain pipe with the layer a second distance vertically;
f. backfill along the layer after placement of the layer every approximately one foot of wall up to approximately three feet below grade;
g. use slip forms to hold the particles in place while backfilling, slide slip forms up prior to compacting backfill;
h. place a root barrier along the layer down to approximately three feet below grade;
i. install side wall end cap over layer at, near, or above grade.

69. The method of claim 57 wherein the layer is installing around the entire perimeter of the in-ground portion of the structure.

70. The method of claim 57 further comprising optimizing the particles for at least one of said functions.

71. The method of claim 70 wherein the step of optimizing comprises adjusting range of particle sizes dependent upon a particular species of insect.

72. The method of claim 70 wherein the step of optimizing comprises adjusting the particles to meet or exceed local regulatory requirements.

73. The method of claim 70 wherein the step of optimizing comprises selecting particle size for drainage needed for local conditions.

74. The method of claim 70 wherein the step of optimizing comprises selecting thickness of layer of the particles for a desired insulation factor.

75. The method of claim 70 further comprising cleaning and drying the particles prior to use.

76. A method of constructing buildings having a portion of structure in-ground comprising:
a. constructing a foundation at least partially in ground;
b. emplacing a layer of granular material between the foundation and the ground;
c. the material adapted to:
i. deter termites;
ii. insulate;
iii. drain;
iv. mitigate radon.

77. A new use for a granular material that includes approximately 88% by weight of granules having at least one dimension between approximately 1.0 and 4.0 mm, comprising:
a. depositing a layer of said granular material between a structure and the ground to reduce radon levels around the structure.

78. The new use of claim 77 wherein said granular material is selected from the group consisting of limestone or other types of stone substantially meeting specified physical properties similar to limestone from stone beds registered by the Iowa State DOT for 3i concrete aggregate, wherein the aggregate resists fracture under loads on the order of 400 kPa-1600 kPa, and has a Mohs Hardness scale of approximately 3.5.

79. The new use of claim 78 wherein the material is comprised of crushed limestone aggregate having physical properties like those of limestone certified by Iowa State DOT for use as 3i mainline interstate highway concrete stone.

80. The new use of claim 77 wherein the granules are compacted to a layer at least approximately 6 inches thick.

81. The new use of claim 77 further comprising providing a ventilation mechanism to exhaust radon away from the structure.

82. A new use for a granular material that includes approximately 88% by weight of granules having at least one dimension between approximately 1.0 and 4.0 mm, comprising:
a. depositing a layer of said granular material between a structure and the ground to improve the drainage system around the structure.

83. The new use of claim 82 wherein said granular material is limestone having properties of claim 9.

84. The new use of claim 83 wherein material is comprised of crushed limestone aggregate.

85. The new use of claim 82 wherein the granules are compacted to a layer at least approximately 6 inches thick.

86. The new use of claim 83 wherein the layer of crushed aggregate is disposed substantially around the entire foundation of the structure.

87. A new use for a granular material that includes approximately 88% by weight of granules having at least on e dimension between approximately 1.0 and 4.0 mm, comprising:
a. depositing a layer of said granular material between a structure and the ground to improve the thermal characteristics around the structure.

88. The new use of claim 87 wherein said granular material is limestone having properties of claim 9.

89. The new use of claim 88 wherein the material is comprised of crushed limestone aggregate.

90. The new use of claim 87 wherein the granules are compacted to a layer commensurate with amount of thermal insulation desired.

91. The new use of claim 88 wherein the layer of crushed aggregate is disposed substantially around the entire foundation of the structure.

92. A method of constructing an under-slab barrier for use in preventing penetration of termites, reducing radon levels, improving drainage, or improving the thermal characteristics of a structure, the method comprising:
a. compacting at least a portion of the soil under the slab;
b. placing a layer of geotextile fabric above the soil;
c. depositing a layer of granular material on top of the geotextile fabric, said granular material includes approximately 88% by weight of granules having at least on dimension between approximately 1.0 and 4.0 millimeters;
d. placing a vapor barrier on top of the layer of granular material; and forming a slab above the barrier.

93. A method of constructing a side wall of a structure at least partially in the ground to prevent penetration of termites, reduce radon levels, improve drainage, or improve the thermal characteristics of a structure, the method comprising:
a. placing a vapor barrier next to the side wall for a first distance between bottom of the side wall and upward;
b. depositing a layer of granular material adjacent the side wall for said first distance between the vapor barrier and the ground at the bottom of the side wall, said granular material includes approximately 88% by weight of granules having at least on dimension between approximately 1.0 and 4.0 millimeters;
c. placing a filter fabric on the outer side of the granular material approximately the first distance;
d. back filling against the filter fabric approximately the first distance;
e. repeat steps a-c for a second distance upward;
f. repeating steps a-c for subsequent distances until near grade.

94. A new barrier for preventing penetration of termites, reducing radon levels, improving drainage or improving the thermal characteristics of a structure, the barrier comprising:
a. a compacted layer of limestone aggregate deposited between the structure and the ground wherein approximately 88% by weight of the granules have a least one dimension between approximately 1.0 and 4.0 millimeters.
